(19) United States
(12) Patent Application Publication
(10) Pub. No.: US 2008/0000969 A1
(43) Pub. Date: Jan. 3, 2008

(54) Electronic Voting Systems

(75) Inventors: Gorm Salomonsen, Egaa (DK); Jens Groth, Aarhus (DK)

Correspondence Address: KNOBBE MARTENS OLSON & BEAR LLP, 2040 MAIN STREET, FOURTEENTH FLOOR, IRVINE, CA, 92614, US

(73) Assignee: CRYPTOMATHIC A/S, Aarhus (DK)

(21) Appl. No.: 10/593,754

(22) PCT Filed: Jan. 24, 2005
(86) PCT No.: PCT/GB05/00231

§ 371 Date: Jun. 22, 2007

(30) Foreign Application Priority Data
Mar. 25, 2004 (GB) 0406722.9
Apr. 7, 2004 (GB) 040913.3
Jun. 16, 2004 (GB) 0413469.8

(51) Int. Cl. G07C 13/00

(52) U.S. Cl. 235/386

(57) ABSTRACT

An electronic voting system, including: a voting device to generate, in response to a voter selection for each of a plurality of voters an encrypted electronic ballot and a printed ballot, both having voter selection data indicating a said voter's choice, said electronic ballot including information to link it to said printed ballot and vice-versa; an electronic vote decryption system configured to decrypt said encrypted electronic ballots including said linking information; and a voting verification system to receive decrypted voter selection data and linking information from said vote decryption system, to receive voter selection data and linking information from said printed ballots and to compare voters' choices for a sample of said printed and electronic ballots linked by said linking information, to verify the voting.

This invention is generally concerned with systems and methods for electronic voting.

An election poses many challenges for the system used for voting, whether this is a manual system, a mechanical one or an electronic one. Traditionally manual systems have been used and are still widely used. For some decades mechanical systems have been used in some countries, and in recent years electronic voting systems have had their breakthrough in a number of countries. Common to all is that very high standards have to be set on the security of the process of voting, such that voters can be confident that the result of the election correctly reflects the votes cast, whereas at the same time secrecy of the votes cast shall be ensured. In fact a long list of apparently conflicting requirements can be stated.

Common for the systems used for general elections in a larger scale today is that they duplicate the basic principles of the manual election, which we will briefly review. A voter enters a voting site, where his identity is checked, after which he receives a ballot and enters a voting booth where he can vote in privacy. He then folds his ballot such that nobody can see what he has voted, enters the public sphere again and drops his ballot into a container. The whole process is monitored by a sufficiently large and diverse group of people such that it can be trusted not to cheat. A number of special cases may exist in the process. For example the first voter may have the opportunity to verify that the container is initially empty and it may be possible to regret the choice in the time span between entering the choice on the ballot and dropping it into the container. After the election the votes are counted. Throughout the whole process it is ensured that at every step everything is monitored by a group of people sufficiently large and diverse to be trusted.

Mechanical and electronic voting systems follow the same principles. In fact it seems that the core element in the design of such systems is that the process shall be changed as little as possible when introducing a new system. For example DRE (Direct Recording Engine) e-voting systems, store individual votes on a memory card such that they can be counted afterwards instead of just keeping track on the statistics to be reported.

However, when using electronic devices a number of properties of the original process are altered in disfavor of the security despite that the process is kept fixed. In particular the following properties are always lacking unless great care is taken:
a) The voter is no longer able to see that what he enters on the machine is actually what is recorded.
b) The officials monitoring the process are no longer able to see that one vote is recorded for each voter.
c) The monitoring of the counting process is no longer efficient since nobody can see what really happens during counting.

This has been known for many years in academic circles and has led to a number of initiatives:
1) Some have tried to inform the public and decision makers about the situation and have been driving a debate that has recently been rather heated as DRE machines have become more widespread.
2) Some have developed the technology for dealing with the new challenges posed by electronic voting system. This has been done as basic research in universities worldwide and in applied research projects like the e-Vote (IST 2000-29518, http://www.instore.gr/evote) and Cybervote (IST-1999-20338, http://www.eucybervote.org) projects as well as in private high tech companies like Cryptomathic.

For background prior art reference can be made to the following:

[DGS] Ivan Damgård, Jens Groth, Gorm Salomonsen “The Theory and Implementation of an Electronic Voting System”, In Gritzalis, D. (Ed.) Secure Electronic Voting, Kluwer Academic Publishers, Boston, USA, November 2002 (ISBN 1-4020-7301-1)

[DJ01] Ivan Damgård and Mads Jurik. “A generalization, a simplification and some applications of Pailliers public-key system with applications to electronic voting”, In Public Key Cryptography '01, pages 119-136. Springer-Verlag, LNCS 1992, 2001.

[NEF01] C. Andrew Neff. “A verifiable secret shuffle and its applications to e-voting”. In proceedings of the 8'th ACM conference on Computer and Communications Security, pages 116-125. ACM Press, 2001.

[NEF03] C. Andrew Neff “Election Confidence”. Version 6, December 2003. Preprint available on www.votehere.net.

[BGR] Mihir Bellare, Juan A. Garay and Tal Rabin: “Fast Batch Verification for Modular Exponentiation and Digital Signatures”, EUROCRYPT 1998, LNCS series 1403, Springer Verlag, pages 236-250.

[DF] Ivan Damgård and Eiichiro Fujisaki: “A Statistically-Hiding Integer Commitment Scheme Based on Groups with Hidden Order”, ASIACRYPT 2002, LNCS series 2501, Springer Verlag, pages 125-142

[F] Jun Furukawa: “Efficient, Verifiable Shuffle Decryption and Its Requirement of Unlinkability”, Public Key Cryptography 2004, LNCS series, Springer Verlag, pages 319-332.

[FMMOS] Jun Furukawa, Hiroshi Miyauchi, Kengo Mori, Satoshi Obana and Kazue Sako: “An Implementation of a Universally Verifiable Electronic Voting Scheme based on Shuffling”, Financial Cryptography 2002, LNCS series 2357, Springer Verlag, pages 16-30.

[FS] Furukawa and Sako: “An efficient scheme for proving a shuffle”, CRYPTO 2001, LNCS series 2139, Springer Verlag, pages 368-387.

[G] Jens Groth: “A Verifiable Secret Shuffle of Homomorphic Encryptions”, Public Key Cryptography 2003, LNCS series 2567, Springer Verlag, pages 145-160

[GMY] Juan A. Garay, Philip D. MacKenzie and Ke Yang: “Strengthening Zero-Knowledge Protocols Using Signatures”, EUROCRYPT 2003, LNCS series 2656, Springer Verlag, pages 177-194.

[Npatent] Andrew Neff, VoteHere: “Verifiable secret shuffles of encrypted data, such as ElGamal encrypted data for secure multi-authority elections”, patent application 2002.

Further background information useful for understanding the invention can be found in “Verifiable e-Voting” by C. A. Neff and J. Adler, Aug. 6, 2003.

Pursuers of 1) require printed ballots to be produced for voters to watch and store the traditional way such that they can be used for recounting. The pilot system developed and tested in the e-Vote project uses digitally signed, encrypted votes, such that it is ensured that there is control of, who cast each individual vote. It also utilizes a secure protocol based on homomorphic encryption and zero-knowledge proofs (see [DGS], [DJ01]) to ensure that the counting process is universally verifiable while preserving secrecy. Universally verifiable means that it is possible for an independent observer to verify that the votes are authentic, correctly formatted and have been counted correctly without breaking the secrecy of the election. However, it does not deal directly with the issue mentioned in a), that each voter shall be able to verify that his choice is actually what is recorded in his vote. Votes with the e-Vote system are generated and signed in an applet on the PC of the voter, so a) can be ensured by intercepting the applet and verifying that it performs correctly (by means of installing third-party software). However, this only works for Internet voting and it comes together with the expense that receipt-freeness is only conditionally possible with Internet voting.

One purpose of embodiments of the present system is to bring together the two approaches in a novel way by showing how an e-voting system can be designed with existing technology such that
I. The properties of embodiments of the system are such that none of the issues a), b) or c) constitutes a significant security treat.
II. Several counting and recounting procedures are possible with different properties with respect to security and cost and where the highest obtainable level of integrity of the result of the election is considerably higher than for traditional manual elections.

Thus in a relaxed political climate costs can be saved and final results of the election can be made available quickly, whereas in a tense political climate, where current manual procedures are insufficient to ensure integrity of elections, the level of security can be increased.

Previous electronic voting systems as described above by Neff et al. provided voters with receipts which they can take away and after polls close use to confirm, for example by telephone or the internet, that their ballot was as intended. However such a system can lack transparency and it is preferable, at least from the point of view of public perception, not to depart so far from a conventional paper-based or manual voting system. Nonetheless manual systems are by no means perfect despite their relative transparency and, as described further below, there is scope for corruption which is unlikely to be detected without fairly extensive recounts.

There is therefore a need for electronic voting systems which provide security and integrity but which nonetheless will engender public trust. In embodiments of the invention described below this is achieved by retaining a printed ballot system which works in conjunction with an electronic system to guarantee a high level of integrity and security.

According to a first aspect of the present invention there is therefore provided an electronic voting system, the system comprising: a voting device configured to generate, in response to a voter selection for each of a plurality of voters an encrypted electronic ballot and a printed ballot, both having voter selection data indicating a said voter's choice, said electronic ballot including information to link it to said printed ballot and said printed ballot including information to link it to said electronic ballot; an electronic vote decryption system configured to receive electronic ballots from said voting device and to decrypt said encrypted electronic ballots including said linking information; and a voting verification system configured to receive decrypted voter selection data and linking information from said vote decryption system, to receive voter selection data and linking information from said printed ballots and to compare voters choices for a sample of said printed and electronic ballots linked by said linking information, to verify the voting.

Either the electronic ballots or the printed (paper) ballots may be sampled but it is preferable to provide a system which allows printed ballots to be sampled and then linked to decrypted electronic ballots to save time in laboriously searching through large numbers of printed ballots. This can be facilitated by means of special ballot box which is configured to sample the paper ballots and, optionally but preferably, scan the printed ballots although in such a way that the sample ballots cannot be influenced.

To facilitate sampling, and then checking, printed ballots rather than electronic encrypted ballots preferably the voter verification system is configured to determine that all the printed ballots carry different linking information, that each printed ballot links to an electronic ballot, and that the number of printed ballots is the same as the number of electronic ballots, for example automatically counting the printed ballots. Making these checks enables the sampling of printed ballots.

A printed ballot may comprise, for example, human readable information indicating the choice(s) of the voter and information linking the printed ballot to an electronic ballot. The linking information shall preferably not identify the voter (in order not to break secrecy of an election, provided that the election is secret) and it shall preferably be in a difficult-to-read (at least for a human) format such as a bar code and shall preferably not be influenced by the voter (in order to prevent coercion, again provided that the election is secret). An example of such information is an identifier of the district followed by a large random number selected by the device used for voting at the time of voting, printed in a bar-code format on the printed ballot. The linking information may be cryptographically protected, for example by including a MAC (Message Authentication Code) or a digital signature in the linking information. If the linking information is cryptographically protected, the cryptographic protection may also protect the choices of the voters (in order to prevent copying of linking information on printed ballots to other ballots with different choices of voters).

An electronic ballot may comprise, for example, voter identification such as the voter's name and encrypted information, preferably electronically signed, this encrypted information indicating the voter's choice. The encrypted information may also include information linking the electronic ballot to a printed ballot and/or this linking information may be provided separately from the encrypted information indicating a voter's choice, but if so must be treated similarly to the encrypted information indicating the voters choices. As described further later, during the counting process the electronic ballots are preferably separated from voter identification information so that they are depersonalized (though this is not essential, the voting then becoming akin to a show of hands). This de-personalization may be made secure by means of one or more electronic shuffles of the electronic ballots, which may be performed in such a way that it can be proved that no votes have been changed, in preferred embodiments using a so-called zero-knowledge proof. In some embodiments each shuffle may also partially decrypt the encrypted electronic ballots; new zero-knowledge proofs or such a process are described later. With such a system it is also possible to separate the shuffling and gradual decryption process from the verification process, which facilitates more rapid data processing.

In another aspect of the invention provides a computer system for verifying an electronic voting system, the computer system comprising: data memory operable to store data to be processed; program memory storing processor implementable instructions; and a processor coupled to said data memory and to said program memory to load and implement said instructions, the instructions comprising instructions for controlling the processor to: receive decrypted voter selection data and linking information from said vote decryption system; receive voter selection data and linking information from said printed ballots; and compare voters choices for a sample of said printed and electronic ballots linked by said linking information to verify the voting.

The invention also provides a device for collecting ballots, the device comprising: a ballot input to accept a ballot submitted by a user; a first ballot holder for holding ballots for checking; a second ballot holder; and a user interface to allow said user to signal to the device an intention to submit said ballot; and a selector responsive to said signal to select substantially at random one of said first and second ballot holders to receive said submitted ballot.

The skilled person will recognize that selection as random does not necessarily imply equal numbers of ballots in the first and second ballot holders. The device may further include a ballot reader to read linking information on the ballot or local storage and/or forwarding over a network.

In another aspect of the invention provides a printed ballot for an electronic voting system configured to count electronic ballots corresponding to printed ballots, said printed ballot bearing information linking the ballot to a said electronic ballot and information to allow a voter to identify one or more choices, the printed ballot being configured or configurable such that said linking information and said choice identification information are both visible, but not simultaneously.

The invention further provides a method of operating an electronic voting system, the method comprising: collecting a vote from a voter; outputting vote as both an encrypted electronic ballot and a printed ballot, each of said printed and encrypted electronic ballots bearing information linking it to the other; displaying the printed ballot to the voter; collecting the printed ballot; repeating said collecting, outputting, displaying and collecting for a plurality of other voters; decrypting and counting said electronic ballots; selecting a sample of said printed or electronic ballots and reading voter choices for said sample; reading voter choices for electronic or printed ballots linked to said selected ballots by said linking information; and comparing said voter choices read from said sample and said linked ballots to verify a result of said voting.

The invention further provides a method of committing to an electronic data value, the method comprising selecting a substantially random number and a sub group of the multiplication group Z*ₙ of integers computed modulo n where n is a product of two primes for the electronic data value and/or said substantially random number and determining a commitment value from said electronic data value and said substantially random number using said subgroup.

The invention further provides a method of providing information for verifying correctness of a permutation of encrypted messages performed using one or more data processing entities, the method comprising: sending a commitment (cₛ) to a first set of values (π) defining said permutation to a verifier; receiving a second set of values (t) from said verifier; permuting said second set of values with said permutation; sending a commitment (cₜ) to said permuted second set of values to said verifier; and sending additional information to said verifier for verifying correctness of said permutation, said additional information verifying that said second set of values was permuted with said permutation. Preferably the sending of additional information comprises: receiving a pair of challenge values (λ, x) from said verifier; determining a third set of values (a) from said permutation, said second set of values and said pair of challenge values and sending a commitment (cₐ) to said third set of values to said verifier; determining and sending a commitment (c_{d}) to a fourth set of random values (d) to said verifier; determining a fifth set of random values (Δ) and sending a commitment (c_{Δ}) to a combination of said fourth and fifth sets of values to said verifier; sending a check value (E) derived from a further random value (R) to said verifier; receiving a further challenge value (e) from said verifier; and sending values (f, z, Z) determined from said further challenge value, said pair of challenge values, said further random value, and said permutation to said verifier; whereby said verifier is able to verify said correctness using a zero-knowledge protocol.

In a related aspect the invention provides a method of providing information for verifying correctness of a combined permutation and partial decryption of encrypted messages performed using one or more data processing entities, the method comprising: sending information to said verifier for verifying correctness of said combined permutation and partial decryption, said information comprising information to enable said verifier to verify said performance using a zero-knowledge protocol. Preferably the information sending comprises: sending a commitment (cₛ) to a first set of values (π) defining said permutation to a verifier; receiving a second set of values (t) from said verifier; permuting said second set of values with said permutation; sending a commitment (cₜ) to said permuted second set of values to said verifier; receiving a pair of challenge values (λ, x) from said verifier; determining a third set of values (a) from said permutation, said second set of values and said pair of challenge values and sending a commitment (cₐ) to said third set of values to said verifier; determining and sending a commitment (c_{d}) to a fourth set of random values (d) to said verifier; sending a triplet of check values (D, U, V) derived from a pair of random values (d, R) to said verifier; receiving a further challenge value (e) from said verifier; and sending values (f, z, Z) determined from said further challenge value, said pair of challenge values, one of said pair of random values, and said permutation to said verifier.

The invention further provides a method of shuffling and decrypting encrypted electronic data using a plurality of data processing entities, each entity having a share of a secret key, the method comprising, at each of said entities, partially decrypting and re-randomizing said electronic data using said secret key share such that a final said data processing utility fully decrypts said data.

The invention also provides a method, in a computer system, of providing data for verifying that messages of a set of messages provided from a corresponding set of entities are authentic, the method comprising: selecting, for each said entity, first second and third random numbers; determining, for each said entity, first and second verification values from, respectively, said first and second random numbers and said entity's message, and said first and third random numbers; and outputting, for each entity, said entity's message and said first and second verification values.

The invention further provides a method for providing data for verification systems for verifying that messages m₁, . . . ,mₖ are authentic using a homomorphic verification system without revealing their origin, the method comprising entities {Eⱼ} producing the messages each choosing random numbers eⱼ, rⱼ and ρⱼ and submitting mⱼ, V(eⱼ, rⱼ) anonymously to one entity (entity A) and V(mⱼ eⱼ, ρⱼ) to another entity (entity B) where V is a verification function, in particular a homomorphic function, in such a way that the messages are authenticated.

The invention also provides computer program code to implement the above described systems and methods. Such code may be provided on a data carrier such as disk, CD- or DVD-ROM, programmed memory such as read-only memory (firmware), or on a data carrier such as an optical or electrical signal carrier. The code may comprise code in any conventional programming language, such as C. As the skilled person will appreciate such code may be distributed between a plurality of coupled components in communication with one another, for example on a network.

We further describe a voting system feature comprising: at least one device used for voting entering preferably (the same or associated information) on a printed ballot and an encrypted electronic ballot linking the two to each other. Preferably each voter is allowed to watch the content of the paper ballot to verify that it contains his choices. Preferably at least one instance makes available depersonalized clear-text electronic ballots with their information linking them to printed ballots to the public or to selected entities. Preferably a procedure selects a random sample of electronic ballots and verifies that their content corresponds to the content of corresponding paper ballots with the purpose of establishing confidence that the electronic ballots have not been subjected to large-scale tampering.

We further describe a voting system feature comprising: at least one device used for voting entering preferably (the same or associated information) on a printed ballot and an encrypted electronic ballot linking the two to each other. Preferably each voter is allowed to watch the content of the paper ballot to verify that it contains his choices. Preferably at least one instance makes available depersonalized clear-text electronic ballots with their information linking them to printed ballots to the public or to selected entities. Preferably a procedure selects a random sample of electronic ballots and verifies that their content corresponds to the content of corresponding paper ballots with the purpose of establishing a deterrent against tampering with the voting device in individual election districts.

We further describe a device for collecting ballots comprising: two or more containers for collecting filled ballots and a user interface allowing a voter to make aware of his intention to submit his ballot arranged in such a way that it is decided at random at the time of ballot submission whether ballots shall be checked. This works in the way that it is by mechanical means ensured that ballots selected for checking at random are entered in a particular subset of containers.

We further describe a protocol for producing a zero-knowledge proof of a correctly preformed combination of permuting and partial decryption of homomorphically encrypted messages, and the non-interactive versions of the protocol obtained by using the Fiat-Shamir heuristic.

We further describe a homomorphic commitment system that performs efficiently by making use of subgroups of Zₙ* for the message space and/or the randomization space.

We further describe a protocol comprising: use of a homomorphic verification system for verifying the correctness of the result of repeatedly permuting and re-encrypting and finally decrypting homomorphically encrypted content.

We further describe a protocol comprising: use of a homomorphic verification system for verifying the correctness of the write-in votes obtained by repeatedly permuting and re-encrypting and finally decrypting homomorphically encrypted votes.

We further describe a protocol comprising: use of a homomorphic verification system for verifying the correctness of the information linking electronic and printed ballots obtained by repeatedly permuting and re-encrypting and finally decrypting homomorphically encrypted votes.

Aspects of the invention provide data processing apparatus and computer program code (which may be distributed over a network), in particular on a carrier, to implement the above described system and protocols.

Embodiments offer faster counting, cost savings and increased service to voters compared to manual elections, but with a higher level of security. Aspects of the invention can be used in many embodiments: There are many technologies available for dealing with the above described issues. In particular all of the technologies “homomorphic encryption”, “MIX nets” and “digital signatures” can be replaced by other technologies in embodiments described later and still provide working systems.

These and other aspects of the present invention will now be further described by way of example only with reference to the accompanying figures in which:

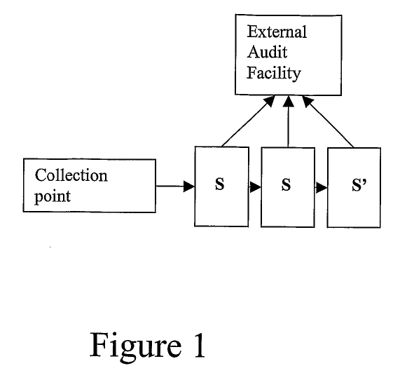

FIG. 1 shows and example of a MIX net;

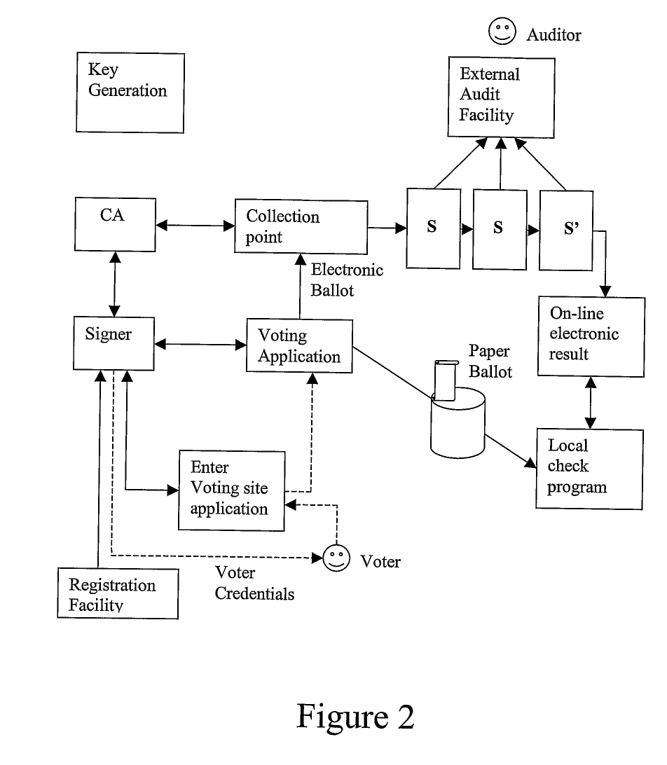

FIG. 2 shows a first embodiment of an electronic voting system according to an aspect of the present invention;

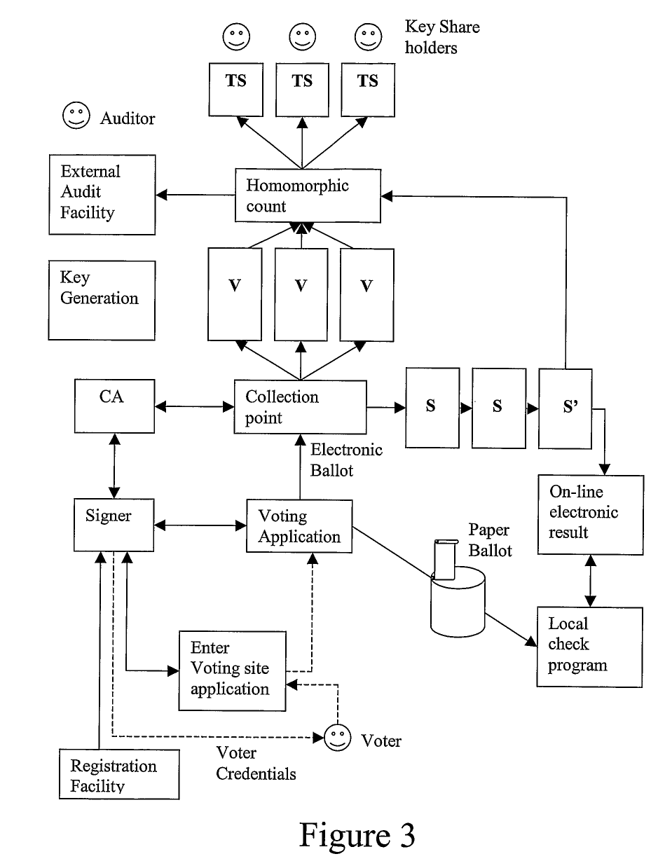

FIG. 3 shows a second embodiment of an electronic voting system according to an aspect of the present invention;

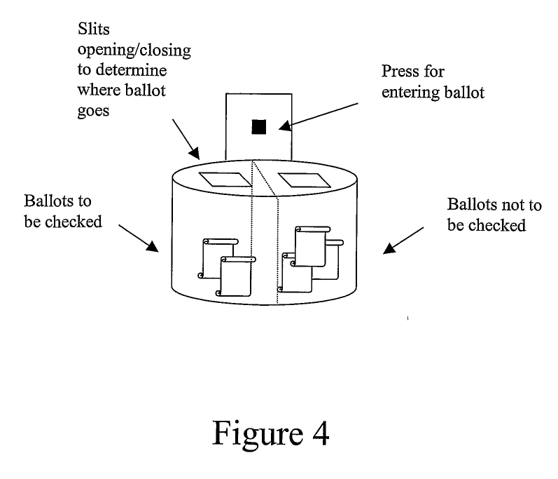

FIG. 4 shows a first embodiment of a device for collecting ballots according to another aspect of the present invention;

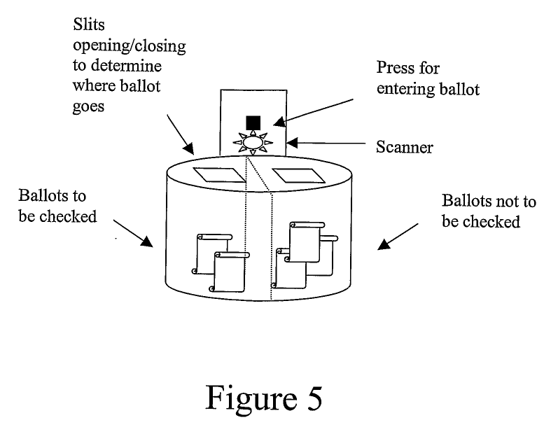

FIG. 5 shows a second embodiment of a device for collecting ballots according to another aspect of the present invention; and

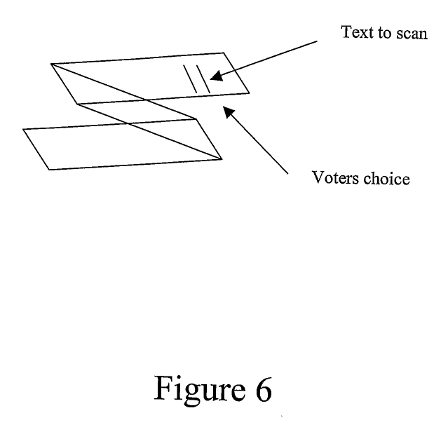

FIG. 6 shows a printed ballot suitable for use with the ballot collecting devices of FIGS. 4 and 5;

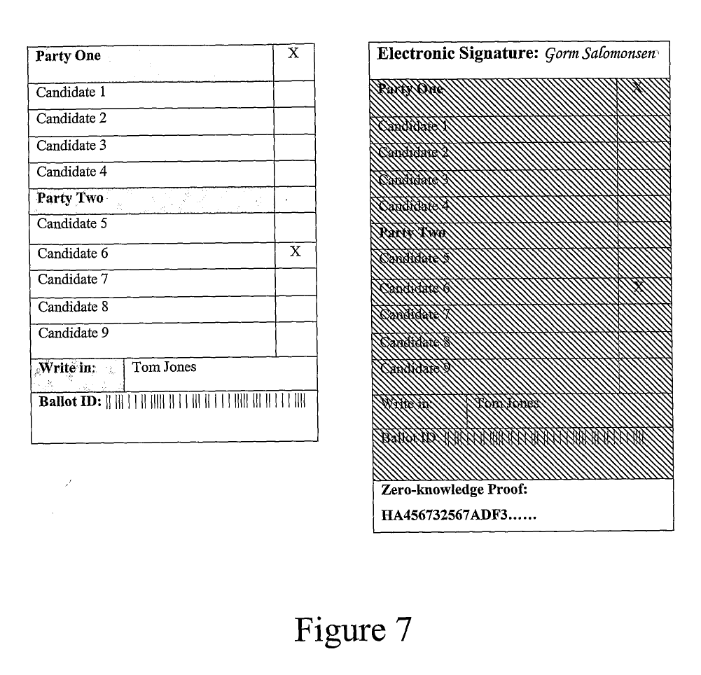

FIG. 7 illustrates the information that can be contained in a paper ballot and in the corresponding electronic vote;

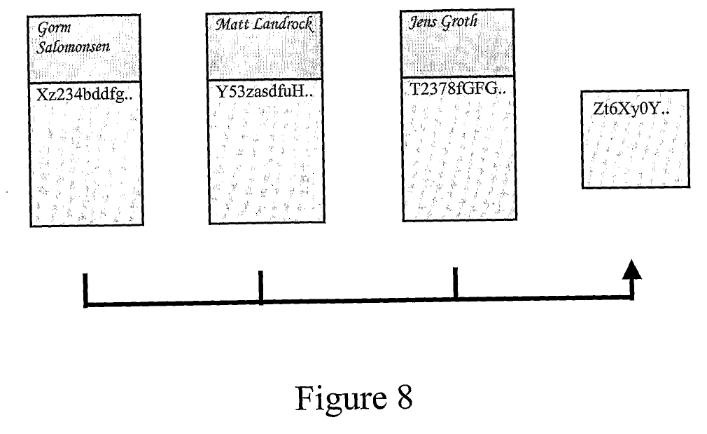

FIG. 8 illustrates how encrypted content may be homomorphically counted on encrypted form to deliver an encrypted result in a homomorphic count; and

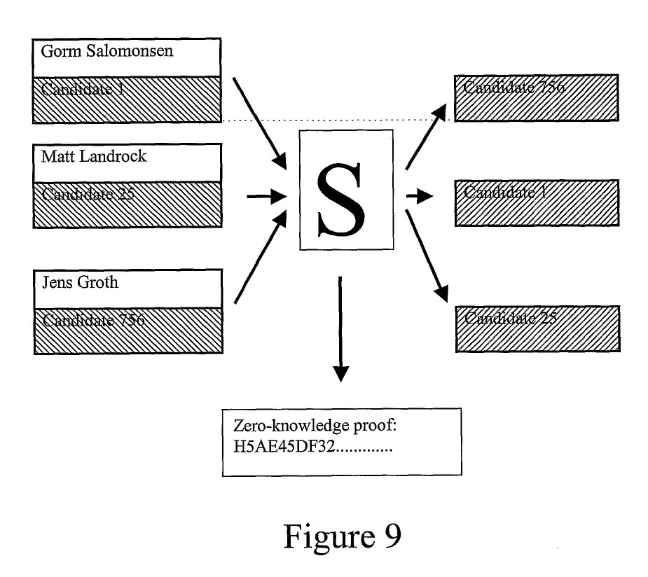

FIG. 9 illustrates how a shuffle changes the encryption and the ordering of electronic votes and produces a zero-knowledge proof.

When we discuss technologies suitable for protecting elections it will be technologies that base their trust on mathematics and suitably composed groups of people being unable to cooperate to cheat rather than in elements like trust in the quality of code or ability to keep out intruders completely. For example a digital signature cannot be forged by malicious software that has access to data that can be signed unless this software also has access to a particular private key. This is contrary to other sorts of protection, like a log on a local machine that can normally easily be forged by malicious software. Thus the protection we discuss is protection against adversaries with access to modifying any part of the software they like with very few exceptions (software for key generation is an example). When we state that a device must be trusted to do or not to do something, we mean that we rely on that the software and hardware of the device ensures that the device has the intended behavior.

The level of security for the devices used for casting votes, we are aiming at is: The devices will be trusted not to give away the choices of individual voters in any other ways than the ones specified. However, we will assume that relevant adversaries have access to modifying the software and hardware of the devices whenever we discuss the highest levels of security supported for protecting against tampering with the choices of the voters.

This is consistent with the fact that the latter type of attack has the highest potential for producing benefits for adversaries, and with that also manual voting allows some attacks, like the use of hidden cameras or comparison of fingerprints on voter cards and ballots, for breaking the secrecy.

Two technologies for counting secret encrypted and signed votes (the list is not exhaustive, the ones mentioned are the ones we are particularly interested in making use of in our invention) are:
Homomorphic encryption and zero-knowledge proofs combined with a secret sharing mechanism. The vote is encrypted and a zero-knowledge proof is attached proving that the encrypted vote is an encryption of a correct or true vote. Because the crypto system is homomorphic the votes with correct zero-knowledge proofs can be counted on encrypted form without ever decrypting a vote. Finally, the key for decrypting the result is secret shared between a sufficiently large and diverse group of people such that it can be trusted not to decrypt individual votes.
MIX nets. A number of servers (shuffles) one after another re-encrypts encrypted votes without being able to decrypt them and passes them on in a different, random order together with a zero-knowledge proof that only the order but not the content of the encrypted votes has been modified. If several shuffles are used one after another and are operated by different organizations with conflicting interests, it is trusted that the association between the original ordering of the votes and the new ordering of differently encrypted votes has been lost. Further, the zero-knowledge proofs ensure that the content of the votes has not been altered. Again a secret sharing mechanism can be used for decryption.

Common to the two approaches is that they employ zero-knowledge proofs and particular protocols. Until recently protocols of this type were too slow to be applied in practice, but we have developed an efficient homomorphic encryption protocol and an efficient MIX net protocol. Both can be implemented over the same homomorphic crypto system.

We have recognized that the two technologies have different properties: Counting including verification can be parallelized arbitrarily for homomorphic encryption, so it scales well and can produce a fast result. Further it is easy to trace back incorrectly formatted electronic votes to their origin with this technology (this should never happen unless machines used for voting are malfunctioning or tampered with—instead there should be a correctly formatted invalid choice). The disadvantage is that a special zero-knowledge proof must be designed for each voting rule. (A voting rule can for example be, that each voter can select one option, vote blank or provide an invalid vote. Another voting rule can be, as used in practice in Greece, that each voter may vote for up to five persons from the same political party or provide an invalid vote. These two rules require different zero-knowledge proofs since different properties of the content of encrypted votes must be proven.) MIX nets are more flexible when it comes to implementing different voting protocols because the same zero-knowledge proofs can be used for all voting rules.

In one of the proposed embodiments of our invention we will combine both technologies in order to get the best properties from both.

The technologies discussed are sufficient to deal with the issues b) and c) mentioned in the introduction, so it remains to discuss the issue a). By having ballots printed voters are provided with the service that they can see what they have voted on paper, and they have the same level of certainty as at a manual election, that their vote will count, provided that a manual recount actually takes place. The idea, as already hinted, however has a number of shortcomings in its pure form: Almost no information is gained by checking a few votes in a district. The only action that makes sense is to make total recounts in a selection of districts. However, if let's say a manual recount takes place in 10% of the districts, this gives a 10% chance of being taken for somebody manipulating votes in a particular district for a particular election. This may well be a chance worth taking for a politician facing a ruined carrier if he looses. The same can be said for a 30% or a 50% chance.

Consequently quite comprehensive recounting is necessary in order to ensure that the mechanism works as intended—not only by revealing attempted fraud, but also by preventing attempts of fraud from happening by acting as a deterrent. Embodiments of an aspect of our invention have the following properties: Electronic votes contain encrypted information identifying the manual vote and preferably the election district. The electronic votes can be detached from the identity of the voter by means of a MIX net or a similar mechanism in a secure way; after being detached from the identities of the voters, they are decrypted. We can pick a random sample of all the electronic votes of an arbitrary size.

We now comment on references to “depersonalization”. A practical system will normally be required to log information about significant actions. In particular temporal information linking specific events to the time they happened is usually logged. For example the Signer (see later, with reference to WO 03/015370) used in embodiments logs the hash value of the information signed together with the time of signature (in embodiments this means that double-voting using the same credentials is logged, which is important for providing accountability). Also the underlying infrastructure, in particular firewalls and Internet operators, may log parts of the network traffic, as may a man-in-the-middle. Combining the time an individual voter votes together with the time particular electronic votes (or hash values of electronic votes) were handled by a component of the system, breaks the secrecy and opens up the possibility of coercion. It is therefore preferable to always consider an electronic vote to be linked to the identity of the voter until it is de-linked from the identity of the voter by a cryptographically sound protocol. We prefer to make it explicit that identities of voters are linked to electronic votes by having the identities linked to the electronic votes in a cryptographically protected way, which in the embodiments provided is done by having a voter signature on each electronic ballot. This feature is however not essential to aspects of the invention. Providing a cryptographically protected identity of individual voters together with the electronic votes means that accountability of, where individual encrypted electronic votes originate from is provided, such that identities of voters whose votes were counted is part of the information that is universally verifiable.

Say that we want to ensure with 99% probability that at most 1% of the electronic votes are tampered with, i.e. contain different choices than the ones entered by the voters. Then we pick 459 random electronic votes. For each of those, if at least 1% of the electronic votes contain different choices than the corresponding manual votes, it has less than a 99% chance of passing the test of being compared to the corresponding manual vote. Consequently there is a probability of less than 0.99⁴⁵⁹=0.009921 that all of them pass the test.

It is clear that letting electronic ballots identify non-existing printed ballots will be discovered. However, letting more electronic ballots identify the same printed ballot is a possible attack unless care is taken. The procedure that must be carried out in the individual districts is therefore to run through all printed ballots in the district to establish that there is exactly one printed ballot with the same identification as the electronic ballot and that the choices on the printed ballot are the same as on the electronic one.

For the ultimate case, a general election in the US say, it means that by manipulating 459 votes out of maybe 100,000,000 or even 200,000,000 and causing the rather simple procedure to happen in 459 randomly chosen election districts, you actually get quite confident that no large scale fraud takes place with the electronic votes. And this is by carrying out a procedure simpler than counting manually in less than 10 election districts in each state in average.

In an aspect of the invention we let each encrypted vote carry information linking it to an individual ballot. After detaching the votes from the identities of the voters, take a sample of random decrypted electronic votes and compare them to the corresponding manual votes (using the linking information) in order to create confidence in the accuracy of the result of the election with relatively little effort.

Additional information on an electronic ballot can be used for coercion by entities with access to decrypted, depersonalized electronic ballots. Therefore the information should be represented on the printed ballot in a form difficult to manage by voters (not easier to copy than taking a photo of the ballot or essential parts of the ballot) and the voter should preferably not be able to influence the information. One possibility is to use random data represented as bar codes on the printed ballots.

The way statistics behave when doing different kinds of checking follows from elementary mathematics. The low efficiency of the standard scheme of producing manual ballots without any other option than doing full recounts for election sites or election districts was also noticed in [NEF03] but in this document using printed ballots was seen as opposed to using testing based on providing voters with receipts, which they may have difficulties with handling and understanding and lacks transparency compared with a printed ballot.

This scheme can also be carried out the other way around, in that paper ballots are picked and compared to anonymised electronic ballots. This has the advantage that less manual work is required. We propose the following scheme: the paper ballots are counted, the number is compared to the number of electronic ballots from the district. Then some paper ballots are picked at random and it is verified that they correspond to electronic ballots and have the same content. If the number of paper ballots and electronic ballots are not the same, the paper ballots are counted. The property we are aiming at using is that if there is the same number of electronic and paper ballots, and a certain number of electronic ballots do not correspond to paper ballots, then the same number of paper ballots do not correspond to electronic ballots. Thus, if we know that the information linking paper ballots to electronic are different and the number of paper ballots correspond to the number of electronic ballots, it is just as efficient to pick random paper ballots. In embodiments this is ensured by scanning the linking information on each paper ballot and let the system verify that all of these properties are satisfied. We are of course aware that it may be a very time consuming and complex task to carry out this comparison manually. If a single entity is not trusted to verify that these properties are satisfied alone, we suggest that a protocol is used between the entity responsible for handling results of scanning the paper votes and the entity responsible for storing depersonalized decrypted electronic votes that ensures that both do the verification. (Example: The entity responsible for handling results of scanning the paper votes submits the result of each the scanning, signed by a private key, awaits a yes/no answer about whether the information matches the information on an electronic ballot and processes the information. The entity storing the depersonalized decrypted electronic votes performs the verification and returns yes/no about whether the information matches the information on an electronic vote, also processes the information, and finally submits the signed result of the scanning for universal verification.).

The procedure described above is efficient for revealing large-scale fraud. However, it still suffers from the deficit that it does not efficiently act as a deterrent against fraud in individual districts. Before we proceed with describing how to install such a deterrent, we will notice the difference between the requirement for having confidence in the overall accuracy of a country-wide election and the requirement for having a deterrent. The first needs to be established quickly such that the result of the election can take effect. For the latter to work, it is however enough that fraud is detected with a high probability inside a reasonable time window, for example a few months. That means that costs can be kept down when repeating the procedure in individual districts by having few MIX net servers (and corresponding high-security facilities and staff) doing the electronic parts, and by giving districts reasonable deadlines for answering results such that they can organize their work efficiently. It also has the advantage that the capability of decrypting votes does not have to be distributed on too many facilities and persons.

We give an example of how an embodiment of another claim of our invention can act as an efficient deterrent.

Say we carry out the procedure described above with 194 randomly chosen votes in each district. Then in each district somebody manipulating 2% of the votes will face a 98% chance that the fraud is detected. (Probabilities are estimated under the assumption that there are much more than 194 votes. Lower number of votes in all cases give higher probability of detection.) If he manipulates 1% of the votes he will face an 86% chance that it is detected and if he manipulates 0.5% of the votes he will face a 62% chance that it is detected. If he manipulates 0.1% of the votes, he will face a 17% chance that it is detected, which is not much, but on the other hand his chances of influencing the outcome of the election by changing 0.1% of the votes are probably also not good. If fraud is detected in this way, a manual recount and a police investigation can be initiated such that the result of the election can be corrected and such that apparently fraudulent candidates and their assistants can be tried in court.

The number of votes checked and the procedure that takes place in case that fraud is detected can of course be tuned according to needs.

In another aspect of the invention we use information in each encrypted vote linking it to an individual ballot. After detaching the votes from the identities of the voters, take a sample of random decrypted electronic votes and compare them to the corresponding manual votes in order to install an effective deterrent against fraud with the election.

We must expect that both the procedure for creating confidence in the result of the election and the deterrent will be used together. Further, this should be done in a manner as efficient as possible. We describe a procedure below:
At each election site/district there is a PC with a scanner capable of reading the information on the paper ballots linking them to electronic ballots, but not necessarily capable of reading what is voted for. The PC is on-line, is running a special application and has access to the electronic anonymised votes.
The paper ballots are scanned and a program on the PC verifies that all the ballots carry different information, that the information corresponds to information on an electronic vote and that the number of paper votes is the same as the number of electronic votes.
A sample of (about 194) randomly chosen votes is collected. For each of those it is verified that the electronic vote corresponds to the paper vote.

We now outline public key cryptosystems.

A public key cryptosystem generally consists of three algorithms K, E, and D.
K is the key generation algorithm and produces a public key, pk, and a secret key, sk.
E is the encryption algorithm. It takes as input the public key pk and a message m. It produces a ciphertext c←Eₚₖ(m). The algorithm may be randomized; it generates some random bits and uses them in the encryption process. When emphasizing these random bits, we write them as an explicit extra input to the encryption algorithm, i.e., c=Eₚₖ(m;r).
D is the decryption algorithm. It takes as input the secret key sk and a ciphertext c. Using this it produces m=Dₚₖ(c).

One particular group of public key cryptosystems is ElGamal-style cryptosystems.

Consider the group Zₚ*, i.e., the multiplicative group of integers modulo p, where p is a prime. Let q be a prime, such that q divides p−1. Then there is a cyclic subgroup G_{q} of Zₚ* with order q. Let g be a generator for this group, i.e., <g>=G_{q}.

The key generation algorithm picks primes q, p and a generator g as described above. It selects at random an element x ε Z_{q} and computes h=g^{x} mod p. It outputs public key pk=(q,p,g,h) and secret key sk=x.

To encrypt a message m ε G_{q} the encryption algorithm picks a random r ε Z_{q} and returns ciphertext c=(u,v)=Eₚₖ(m;r)=(g^{r} mod p, h^{r}m mod p).

The decryption algorithm on a ciphertext c=(u,v) returns m=Dₛₖ(c)=vu^{-x} mod p.

Another variant of the ElGamal cryptosystem uses the group Zₙ_{²}*, where n=pq, and p,q are large primes. The multiplicative group Zₙ_{²}* of elements computed modulo n² has order n*1 cm(p−1,q−1), and the element (1+n) has order n in Zₙ_{²}*.

Here the key generation algorithm outputs two elements g,h of order 1 cm(p−1,q−1), i.e., pk=(n,g,h) and the secret key is sk=x, such that h=g^{x} mod n².

To encrypt a message m ε Zₙ, the encryption algorithm picks a random r and computes ciphertext c=Eₚₖ(m;r)=(g^{r} mod n², h^{r}(1+n)^{m} mod n²).

On ciphertext c=(u,v) the decryption algorithm outputs m=Dₛₖ(c)=((vu^{-x} mod n²)−1)/n.

Please note that ElGamal cryptosystems are examples of homomorphic systems. i.e., Eₚₖ(m₁+m₂;r₁+r₂)=Eₚₖ(m₁;r₁)*Eₚₖ(m₂;r₂). For another type of homomorphic cryptosystem see for instance [DJ01].

Common for ElGamal-style cryptosystems is that we can secret share the secret key. This means that we can have several parties that each get a share of the secret key, and only by cooperating can they perform the decryption operation. This is important in voting, where we want to have strong security guarantees that no single party is capable of decrypting a ciphertext containing a voter's vote.

There are several methods for doing this secret sharing; here we focus only on a simple linear method. Let the secret key be x. We pick at random s₁, . . . ,sₖ such that x=s₁+ . . . +sₖ. Give each party S₁, . . . ,S_{K} the secret share s₁, . . . ,sₖ, they now have a sharing of the secret key, but no proper subset of the parties can compute the secret key.

As a step in decrypting the ciphertext c=(u,v) we want to compute u^{x} (we will from now on not be explicit about the group we are working in, it can be modulo p, modulo n², or a completely different type of group, for instance one based on elliptic curves). The parties S₁, . . . ,Sₙ can cooperatively do so. They simply compute u₁=u^{s1}, . . . ,uₖ=u^{sk}, and publish their decryption shares. Now, anybody can compute vu^{-x}=v(u₁ . . . *uₖ)⁻¹, and from that extract the message.

There is a problem though. Imagine a party Sᵢ cheats and supplies an incorrect decryption share. In that case, we may end up with believing that the plaintext is something completely different from the message that was actually encrypted. To solve this we let the key generation algorithm compute verification keys h₁=g^{s1}, . . . ,hₖ=g^{sk}, and output these together with the public key. We now demand that each server Sᵢ makes a zero-knowledge proof that uᵢ has been computed with the same exponent sᵢ as has been used to compute hᵢ. We will explain the notion of zero-knowledge proofs later, for now let us say that it proves the correct use of exponent sᵢ, without revealing anything about sᵢ.

We now describe commitments.

In an example of a bit commitment protocol Alice chooses a bit and sends proof to Bob although, due to the character of the proof, Bob cannot tell what Alice's bit is until she tells him. Once she does, Bob can easily verify that she is telling the truth; a simple case is a piece of paper in a locked box.

A commitment scheme generally consists of three algorithms K, C, and V.
K is a key generation algorithm that outputs a public key pk.
C is a commitment algorithm. It takes as input the public key pk and a message m. It outputs a commitment c←Cₚₖ(m). C is a randomized algorithm, and when needed we write the random bits used as r, and have c=Cₚₖ(m;r).
V is a verification algorithm that outputs accept or reject. It takes as input a public key pk, a commitment c, an opening (m,r). It outputs accept if and only if c=Cₚₖ(m;r).

For the algorithms K, C, V to constitute a commitment scheme, we require that the commitment is hiding and binding.

Hiding means that from a commitment c it must be infeasible to tell which message m is inside it. Hiding comes in two flavors, computational hiding and the stronger statistical hiding. A commitment is statistically hiding, when even given infinite computing power it is still impossible to tell anything about the message inside the commitment.

Binding means that it is impossible to find a commitment c and two different openings (m₁,r₁) and (m₂,r₂) such that the verification algorithm will accept both openings. Also the binding property comes in two flavors, computational and statistical. A commitment is statistically binding if even with infinite computing power it is impossible to form a commitment c that can be opened in two different ways.

From the cryptographic literature a commitment cannot both be statistically hiding and statistically binding at the same time. It is possible to have commitments that are statistically binding and computationally hiding, and in fact, the ElGamal cryptosystems mentioned above are examples of such commitments. In the following, we present three examples of the opposite case, namely statistically hiding and computationally binding commitments.

Consider again the group Zₚ*, and the cyclic subgroup G_{q} of order q. Let g,h be two randomly chosen generators for this group, i.e., <g>=<h>=G_{q}. The public key output by the key generation algorithm is pk=(q,p,g,h).

To commit to a message m ε Z_{q} we pick at random r ε Z_{q}, and let the commitment be c=g^{r}h^{m} mod p.

An opening of the commitment c consists of (m,r), and V outputs accept if and only if m ε Z_{q}, r ε Z_{q}, and c=g^{r}h^{m} mod p.

Another example of a commitment scheme is the following integer commitment scheme. We use the group Zₙ*, where n=pq is a product of two primes, such that p−1 and q−1 do not have any small odd divisors. The key generation algorithm picks two squares g,h in Zₙ* at random.

To commit to an integer m, select r as a random 2|n|-bit number, where |n| denotes the number of bits in n, and compute the commitment c=Cₚₖ(m;r)=g^{r}h^{m} mod n.

An opening of the commitment consists of (b,m,r) such that b is a square root of 1, and c=bg^{r}h^{m} mod n.

An important property of the above examples of commitment schemes is that they are homomorphic. I.e., Cₚₖ(m₁+m₂;r₁+r₂)=Cₚₖ(m₁;r₁)*Cₚₖ(m₂;r₂).

We can easily extend the commitments to commit to several values at once. Let the public key consist of g,h₁, . . . ,hₙ. Then we can commit to m₁, . . . ,mₙ as c=g^{r}h₁^{m1} . . . hₙ^{mn}.

In an aspect of the invention we describe the following variation of an integer commitment scheme.

Let n=pq be the product of two primes p and q. Let furthermore, p′,q′ be two primes dividing respectively p−1 and q−1. Reasonable sizes are |p|=|q|=512 bits, where |p| denotes the number of bits in p, and |p′|=|q′|=128 bits. Both p,q,p′ and q′ must be kept secret. Let furthermore, t be an integer such that t>|p′|+|q′|. For instance we could with the above parameters select t=300.

Pick at random g,h such that <g>=<h> are groups of order p′q′.

The key generation algorithm outputs the public key pk=(n,g,h,t).

To commit to an integer m, pick at random r as a t-bit number. Compute the commitment c=Cₚₖ(m;r)=g^{r}h^{m} mod n.

To open the commitment reveal the opening (m,r). The verification algorithm on opening (m,r) checks that c=g^{r}h^{m} mod n.

Variations of the Scheme:

As mentioned before it is possible to make a variation of the integer commitment scheme that allows for commitment to multiple integers at once.

One can select p′,q′ such that they are composites. It is important, however, that they are selected such that it is hard to guess a number N such that p′|N or q′|N.

Note that we deliberately work in a moderately small subgroup of Zₙ* in order to gain better efficiency. This has potential use in both voting protocols and many other cryptographic protocols.

We Now Describe Zero-Knowledge Proofs

For example to prove a statement such as “I know a modular square root” the prover can give the square root to the verifier or provide a so-called zero-knowledge proof to convince the verifier that the statement is true without providing any information on the proof and thus keeping the square root secret. A zero-knowledge proof or zero-knowledge argument comprises an interactive protocol to be run between two parties (or in some cases more parties). We call them respectively the prover and the verifier. Both of them know some common input x, and now the prover wants to convince the verifier that x has some particular property, for instance that there exists a witness w such that (x,w) belongs to some NP-language. To do so, they exchange messages according to the zero-knowledge protocol, and in the end, the verifier decides whether to accept or reject the statement.

We generally call such an interactive protocol a zero-knowledge argument if it has the following three properties
Completeness: If the prover knows a witness w for the property of x, then he can make an honest verifier accept.
Soundness: If the statement is false, i.e., no such w exists; any (possibly cheating) prover cannot make an honest verifier accept.
Zero-knowledge: Any (possibly cheating) verifier does not learn anything but the veracity of the statement from interacting with an honest prover.

There are many variations of how to define zero-knowledge proofs and arguments. Among them are non-interactive variants, where we instead assume a common reference string, chosen with some particular distribution, is available to both prover and verifier. Non-interactive zero-knowledge proofs and arguments are publicly verifiable.

Another variation is honest verifier zero-knowledge, where the zero-knowledge property holds if the verifier follows the protocol, but may not hold if the verifier deviates from the protocol. A stronger version of this is special honest verifier zero-knowledge, where the verifier's messages are public coin (i.e., consists of uniformly random bits) and where it is possible to simulate the entire proof (without knowledge of the witness w) if we are given in advance the messages (challenges) that the verifier sends.

A popular method for making a special honest verifier zero-knowledge proof non-interactive is the Fiat-Shamir heuristic. In the Fiat-Shamir heuristic, we compute the challenges as suitable hash-values. This means that we do not need a verifier to choose the challenges. Broadly speaking, in the so-called random oracle model, hash values of messages are considered to be uniformly distributed random numbers picked the first time a hash of a given message is computed. Since randomness of considerable size is contained in the relevant encryptions and commitments, messages sent from prover to verifier can be considered to be new each time and their hash values are thus uniformly distributed random numbers in the random oracle model. Since also challenges are uniformly distributed random numbers, the hash values can be used as challenges provided that the output from the hash function has the same size as the challenges. The non-interactive proof is thus as secure as the interactive protocol in the random oracle model.

Suppose we have a bunch of (homomorphic) ciphertexts e₁←Eₚₖ(m₁), . . . ,eₙ←Eₚₖ(mₙ). We want to create another set of ciphertexts containing the messages m₁, . . . ,mₙ, but in a random order.

A group of servers S₁, . . . ,Sₖ cooperating to do so is called a mix-net. Using homomorphic encryption, we can construct a mix-net in a simple manner.

Server S₁ re-randomizes the ciphertexts and outputs them in a permuted order. I.e., S₁ selects a permutation π, randomizers R₁, . . . ,Rₙ and outputs E₁=e_{π(1)}Eₚₖ(0;R₁), . . . , (Eₙ=e_{π(n)}Eₚₖ(0;Rₙ). Here π(i) is the index that the i'th index is permuted into by π.

Call the outputs from the previous shuffle e₁, . . . ,eₙ. Server S₂ selects another permutation π, other randomizers R₁, . . . ,Rₙ and outputs E₁=e_{π(1)}Eₚₖ(0;R₁), . . . , (Eₙ=e_{π(n)}Eₚₖ(0;Rₙ). The following servers rerandomize and permute in a similar fashion.

When the last server Sₖ has performed a shuffle, then E₁, . . . ,Eₙ contain a permutation of m₁, . . . ,mₙ. More precisely, if we call the permutations selected by S₁, . . . ,Sₖ for π₁, . . . ,πₖ, and let π(•)=π₁( . . . (πₖ(•) . . . ), then we have E₁ contains m_{π(1)}, . . . ,Eₙ contains m_{π(n)}.

However, only if all servers cooperate will they know π and be able to link messages to their ciphertexts. Conversely, if just a single server is honest, then the permutation is secret.

Mix-nets are useful in anonymization protocols since they allow obfuscation of the relationship between sender and ciphertext. One example area where they are useful is in the area of electronic voting where the connection between a voter and his vote must be secret.

We next describe shuffle verification.

A problem in the above mix-net is how to avoid that one of the servers replaces ciphertexts with encryptions of other messages. A solution to this problem is to let each server make a zero-knowledge argument of correctness of the shuffle-and-decrypt operation it performs.

I.e., call the input ciphertexts e₁, . . . ,eₙ and the output ciphertexts E₁, . . . ,Eₙ. The prover has private input π,R₁, . . . ,Rₙ such that E₁=e_{π(1)}E(0;R₁), . . . , Eₙ=e_{π(n)}Eₚₖ(0;Rₙ).

An aspect of the invention provides the following method to demonstrate that indeed e₁, . . . ,eₙ,E₁, . . . ,Eₙ are on the form described above, without revealing π, R₁, . . . ,Rₙ.

We use additional “public” data in form of a public key for a commitment scheme. We omit explicitly writing the public keys, and simply write respectively mcom. Multi-commitment mcom is used for committing to multiple messages at once, in our case n messages. Furthermore, it has a homomorphic property. I.e., mcom(m₁+M₁, . . . ,mₙ+Mₙ;r+R)=mcom(m₁, . . . ,mₙ;r)*mcom(M₁, . . . ,Mₙ;R).

The idea is now to commit to the permutation π in the first step. Receive challenges t₁, . . . ,tₙ and commit to them in the same permuted order in the third step. In the last four rounds we then prove that we have indeed permuted them in the same way. Furthermore, in the last rounds we show that e₁^{λ+t}₁ . . . eₙ^{λn+t}ₙ=E₁^{λπ(1)+t}_{π(1)} . . . Eₙ^{λπ(n)+t}_{π(n)}.

The protocol proceeds in 7 steps:

Common input: e₁, . . . ,eₙ,E₁, . . . ,Eₙ and public keys.

Prover's input: A permutation πε Σₙ, and randomizers R₁, . . . ,Rₙ satisfying E₁=e_{π(1)}E(0;R₁), . . . , Eₙ=e_{π(n)}Eₚₖ(0;Rₙ).
1. Prover: Pick rₛ at random and set cₛ=mcom(π(1), . . . ,π(n);rₛ). Send cₛ to the verifier.
2. Verifier: Pick t₁, . . . ,tₙ at random and send them to the prover.
3. Prover: Select rₜ at random and set cₜ=mcom(t_{π(1)}, . . . ,t_{π(n)};rₜ). Send cₜ to the verifier.
4. Verifier: Pick λ,x at random and send them to the prover.
5. Prover: For j=1, . . . ,n let aⱼ=Πᵢ₌₁^{j}(λπ(i)+tₓ₍ᵢ₎−x). Select d₁, . . . ,dₙ at random. Select r_{d} at random and set c_{d}=mcom(d₁, . . . ,dₙ;r_{d}). Select R at random. Set E=Eₚₖ(0;R)E₁^{d}₁ . . . Eₙ^{d}ₙ. Select Δ₂, . . . ,Δₙ₋₁ at random and set Δ₁=d₁,Δₙ=0. Select rₐ at random and set cₐ=mcom(Δ₂−(λπ(2)+t_{π(2)}−x)Δ₁-a₁d₂, . . . ,Δₙ−(λπ(n)+t_{π(n)}−x)Δₙ₋₁−aₙ₋₁dₙ;rₐ). Select r_{Δ} at random and set c_{Δ}=mcom(−d₂Δ₁, . . . ,−dₙΔₙ₋₁;r_{Δ}). Send cₐ,c_{d},c_{Δ},E to the verifier.
6. Verifier: Pick e at random and send it to the prover.
7. Prover: Set f₁=e(λπ(1)+t_{π(1)})+d₁, . . . ,fₙ=e(λπ(n)+t_{π(n)})+dₙ. Set z=e(λrₛ+rₜ)+r_{d}. Let f_{Δ1}=e(Δ₂−(λπ(2)+t_{π(2)}−x)Δ₁−a₁d₂)−Δ₁d₂, . . . ,f_{Δn-1}=e(Δₙ−(λπ(n)+t_{π(n)}−x)Δₙ₋₁−aₙ₋₁dₙ)−Δₙ₋₁dₙ and z_{Δ}=erₐ+r_{Δ}. Set Z=R−e(λπ(1)+t_{π(1)})R₁− . . . −e(λπ(n)+t_{π(n)})Rₙ. Send f₁, . . . ,fₙ,z,f_{Δ1}, . . . ,f_{Δn-1},z_{Δ},Z to the verifier.

Verification:

Check that mcom(f₁, . . . ,fₙ;z)=(cₛ^{λ}cₜ)^{e}c_{d}.

Check that mcom(f_{Δ1}, . . . ,f_{Δn-1};z_{Δ})=cₐ^{e}c_{Δ}.

Define F₁,F₂, . . . ,Fₙ as the elements such that

F₁=f₁−ex,eF₂=F₁(f₂−ex)+f_{Δ1}, . . . ,eFₙ=Fₙ₋₁(fₙ−ex)+f_{Δn-1}. Verify that Fₙ=eΠᵢ₌₁ⁿ(λi+tᵢ−x).

Check that Eₚₖ(0;Z)E₁^{f}₁ . . . Eₙ^{f}ₙ=(e₁^{λ1+t}₁ . . . eₙ^{λ+t}ₙ)^{e}E.

The protocol above is seven move public coin, complete, sound and honest verifier zero-knowledge proof of a correct shuffle.

Efficient zero-knowledge proofs for proving correctness of a shuffle exist [FS,G,NEF01,Npatent]. Embodiments of our proposed shuffle proof are more efficient than previous zero-knowledge proofs.

We now describe decrypting mix-nets embodying aspects of the present invention. We now assume that the cryptosystem is an ElGamal-style cryptosystem.

Suppose we have a bunch of ciphertexts e₁=(u₁,v₁)=Eₚₖ(m₁), . . . ,eₙ=(uₙ,vₙ)=Eₚₖ(mₙ). We want to learn the messages m₁, . . . ,mₙ, but in a random order, we do not want anybody to be able to link messages and ciphertexts.

A group of servers cooperating to do so is called a decrypting mix-net. Using ElGamal-style encryption, we can construct a decrypting mix-net in a simple manner. Using the secret sharing described before the servers S₁, . . . ,Sₖ each have a share s₁, . . . ,sₖ of the secret key such that x=s₁+ . . . +sₖ.

Server S₁ peels off the layer of encryption corresponding to its own secret share, it re-randomizes the ciphertexts and outputs them in a permuted order. I.e., S₁ selects a permutation π, randomizers R₁, . . . ,Rₙ and outputs (U₁=g^{R1}u_{π(1)}, V₁=(h₂* . . . *hₖ)^{R1}v_{π(1)} u_{π(1)}^{-s1}), . . . , (Uₙ=g^{Rn}u_{π(n)}, Vₙ=(h₂* . . . *hₖ)^{Rn}v_{π(n)}u_{π(n)}^{-s1}). Here π(i) is the index that the i'th index is permuted into by π.

Server S₂ peels off another layer of the encryption corresponding to its secret share. I.e., if we call the output from S₁ (u₁,v₁), . . . ,(uₙ,vₙ), then it selects a permutation π, randomness R₁, . . . ,Rₙ and outputs (U₁=g^{R1}u_{π(1)}, V₁=(h₂* . . . *hₖ)^{R1}v_{π(1)}u_{π}(1)^{-s1}), . . . , (Uₙ=g^{Rn}u_{π(n)}, Vₙ=(h₃* . . . *hₖ)^{Rn}v_{π(n)}u_{π(n)}^{-sn}). The following servers perform similar shuffle-and-decrypt operations.

When the last server Sₖ peels off a layer of the encryption, then V₁, . . . ,Vₙ constitute a permutation of m₁, . . . ,mₙ. More precisely, if we call the permutations selected by S₁, . . . ,Sₖ for π₁, . . . ,πₖ, and let π(•)=π₁( . . . (πₖ(•) . . . ), then we have V₁=m_{π(1)}, . . . ,Vₙ=m_{π(n)}. However, only if all servers cooperate will they know π and be able to link messages to their ciphertexts. Conversely, if just a single server is honest, then the permutation is secret.

Decrypting mix-nets are useful for voting, since they allow encrypted votes to be decrypted and permuted. This way votes can be counted, but at the same time, nobody can link voters with their votes. Another use could be anonymous publication of messages.

We next describe shuffle-and-decrypt verification.

A problem in the above decrypting mix-net is how to avoid that one of the servers replaces encrypted messages with ciphertexts containing other messages. One possible solution to this problem is to let each server make a zero-knowledge argument of correctness of the shuffle-and-decrypt operation it performs.

I.e., call the input (u₁,v₁), . . . ,(uₙ,vₙ) and the output (U₁,V₁), . . . ,(Uₙ,Vₙ). Furthermore, let G,h and H be public.

The prover has private input π,R₁, . . . ,Rₙ and s, such that h=G^{s} and (U₁=G^{R1}u_{π(1)}, V₁=H^{R1}v_{π(1)}u_{π(1)}^{-s), . . . , (U}ₙ=G^{Rn}u_{π(n)}, Vₙ=H^{Rn}v_{π(n)}u_{π(n)}^{-s}).

We think of h as the verification key for the prover that performs the shuffle, and H as the product of the verification keys for all the remaining servers. In the shuffle the server then transforms ElGamal-style encryptions under key (G,hH) into ElGamal-style encryptions under key (G,H).

An aspect of the invention provides the following method to demonstrate that indeed (u₁,v₁), . . . ,(uₙ,vₙ),(U₁,V₁), . . . ,(Uₙ,Vₙ), G,h,H is on the form described above, without revealing π, R₁, . . . ,Rₙ and s.

We need additional public data in form of a public key for a commitment scheme. We omit explicitly writing the public key, and simply write respectively mcom.

Multi-commitment mcom is used for committing to multiple messages at once, in our case n messages. Furthermore, it has a homomorphic property. I.e., mcom(m₁+M₁, . . . ,mₙ+Mₙ;r+R)=mcom(m₁, . . . ,mₙ;r)*mcom(M₁, . . . ,Mₙ;R).

The protocol proceeds in 7 steps:

Common input: (u₁,v₁), . . . ,(uₙ,vₙ),(U₁,V₁), . . . ,(Uₙ,Vₙ) and public keys, including G,H,h.

Prover's input: A permutation π ε Σₙ, an exponent s and randomizers R₁, . . . ,Rₙ satisfying G^{s}=h and

(U₁,V₁)=(G^{R}₁u_{π(1)},H^{R}₁v_{π(1)}u_{π(1)}^{-s}), . . . ,(Uₙ,Vₙ)=(G^{R}ₙu_{π(n)},H^{R}ₙv_{π(n)}u_{π(n)}^{-s}).
1. Prover: Pick rₛ at random and set cₛ=mcom(π(1), . . . ,π(n);rₛ). Send cₛ to the verifier.
2. Verifier: Pick t₁, . . . ,tₙ at random and send them to the prover.
3. Prover: Select rₜ at random and set cₜ=mcom(t_{π(1)}, . . . , t_{π(n)};rₜ). Send cₜ to the verifier.
4. Verifier: Choose λ,x at random and send them to the prover.
5. Prover: For j=1, . . . ,n let aⱼ=Πᵢ₌₁^{j}(λπ(i)+t_{π(i)}−x). Select d₁, . . . ,dₙ at random. Select r_{d} at random and set c_{d}=mcom(d₁, . . . ,dₙ;r_{d}). Select Δ₂, . . . ,Δₙ₋₁ at random and set Δ₁=d₁,Δₙ=0. Select r_{Δ} at random and set c_{Δ}=mcom(−d₂Δ₁, . . . ,−dₙΔₙ₋₁;r_{Δ}). Select rₐ at random and set cₐ=mcom(Δ₂−(λπ(2)+t_{π(2)}−x)Δ₁−a₁d₂, . . . ,Δₙ−(λπ(n)+t_{π(n)}−x)Δₙ₋₁−aₙ₋₁dₙ;rₐ). Select d at random and set D=G^{d}. Select R at random. Set U=G^{R}U₁^{d}₁ . . . Uₙ^{d}ₙ. Set V=H^{R}(u₁^{λ+t}₁ . . . uₙ^{λ+t}ₙ)^{d}(V₁^{d}₁ . . . Vₙ^{d}ₙ). Send cₐ,c_{d},c_{Δ},D,U,V to the verifier.
6. Verifier: Select e at random and send it to the prover.
7. Prover: Set f₁=e(λπ(1)+t_{π(1)})+d₁, . . . ,fₙ=e(λπ(n)+t_{π(n)})+dₙ. Set z=e(λrₛ+rₜ)+r_{d}. Let f_{Δ1}=e(Δ₂−(λπ(2)+t_{π(2)}−x)Δ₁−a₁d₂)−Δ₁d₂, . . . ,f_{Δn-1}=e(Δₙ−(λπ(n)+t_{π(n)}−x)Δₙ₋₁−aₙ₋₁dₙ)−Δₙ₋₁dₙ and z_{Δ}=erₐ+r_{Δ}. Set Z=R−e(λπ(1)+t_{π(1)})R₁− . . . −e(λπ(n)+t_{π(n)})Rₙ. Set f=es+d. Send f₁, . . . ,fₙ,z,f_{Δ1}, . . . ,f_{Δn-1},z_{Δ},Z,f to the verifier.

Verification:

Check that mcom(f₁, . . . ,fₙ;z)=(cₛ^{λ}cₜ)^{e}c_{d}. Check that mcom(f_{Δ1}, . . . ,f_{Δn-1};z_{Δ})=cₐ^{e}c_{Δ}.

Define F₁,F₂, . . . ,Fₙ as the elements such that

F₁=f₁−ex,eF₂=F₁(f₂−ex)+f_{Δ1}, . . . ,eFₙ=Fₙ₋₁(fₙ−ex)+f_{Δn-1}. Verify that Fₙ=eΠᵢ₌₁ⁿ(λi+tᵢ−x).

Check that G^{Z}U₁^{f}₁ . . . Uₙ^{f}ₙ=(u₁^{λ+t}₁ . . . uₙ^{λn+t}ₙ)^{e}U. Verify that G^{f}=h^{e}D. Check that H^{Z}V₁^{f}₁ . . . Vₙ^{f}ₙ=(v₁^{λ+t}₁ . . . vₙ^{λn+t}ₙ)^{e}(u₁^{λ+t}₁ . . . uₙ^{λn+t}ₙ)^{-f}V.

The protocol above is a seven-move public coin, complete, sound and honest verifier zero-knowledge proof of correctness of a shuffle-and-decrypt operation.

For ElGamal-style ciphertexts the shuffle-proof for homomorphic encryptions described earlier is a special case with s=0, d=0 and therefore f=0.

Efficient proofs for proving correctness of decryption are well known in the cryptographic literature. Likewise, many proofs of correctness of a shuffle exist [FS,G,NEF01,Npatent]. Embodiments of our proposed shuffle-and-decrypt proof are zero-knowledge and more efficient than previous proofs. The shuffle-and-decrypt proofs in [F,FMMOS] are not zero-knowledge. Shuffle-and-decrypt proofs can be used in anonymization protocols; voting protocols is one particular instance of protocols where anonymization is useful.

We now give some comments that pertain to both the zero-knowledge proof for correctness of a shuffle and the zero-knowledge proof for correctness of a shuffle-and-decrypt operation.

One possible way to pick the parameters of the shuffle proof, or the shuffle-and-decrypt proof, is such that the message space of the commitment scheme and the message space of the cryptosystem has the same order. For instance we could let the commitment scheme have public key (p,q,g, h₁, . . . ,hₙ) with p being a 1500-bit prime, q being a 160-bit prime dividing p−1, and the rest being generators of the group G_{q} in Zₚ*. We select the t's, λ,x,e as random challenges from Z_{q} and also the d's and Δ's as random elements from Z_{q}. The cryptosystem could be ElGamal encryption with public key (P,q,G,H) with P being a 3000-bit prime, and q being the same prime as in the commitment scheme dividing P−1, and (G,H) being generators of the group H_{q} in Z_{P}*.

Another way to pick the parameters is such that we actually compute the elements f₁, . . . ,fₙ over the integers. I.e., we could let the commitment scheme have public key (p,q,g,h₁, . . . ,hₙ) with p being a 1500-bit prime, q being a 400-bit prime dividing p−1, and the rest being generators of the group G_{q} in Zₚ*. We select the t's and λ as random 160-bit challenges. Provided we have less than a million messages to shuffle a value e(λi+tᵢ) is at most 340 bits and does not get reduced modulo q in Z_{q}. Picking the d's as random elements in Z_{q} we get f's that with overwhelming probability are more than 340 bits long, something that we can check in the verification phase. This means that over the integers we have fᵢ=e(λπ(i)+t_{π(i)})+dᵢ for i=1, . . . ,n. This in turn means, as long as the message space of the cryptosystem does not have small divisors, that we have shuffled or shuffle-and-decrypted correctly. In particular, we could use such a method to shuffle ciphertexts from the generalized Paillier cryptosystem of [DJ01], which has a very large message space and where current shuffling techniques are not as practical.

Using the Fiat-Shamir heuristic, i.e., computing the challenges t₁, . . . ,tₙ, λ, x, ε and e as suitable cryptographic hashes makes the protocols non-interactive. This way the zero-knowledge proofs can also be made publicly verifiable.

If the servers are to run either of the protocol interactively, then we note that [GMY] suggests general techniques to transform honest verifier zero-knowledge proofs into zero-knowledge proofs.

Using randomization it is possible to speed up the verification process, see [DGS] and [BGR] for comments on batching techniques. It is furthermore well known that various techniques for fast multiple exponentiation exist.

For instance, instead of verifying the last two equations in the shuffle-and-decrypt proof by themselves, we can pick γ as a small random number and check whether (G^{γ}H)^{Z}(U₁^{γ}V₁)^{f1} . . . (U₁^{γ}Vₙ)^{fn}=(v₁^{λ+t1} . . . vₙ^{λn+tn})^{e}(u₁^{λ+t1} . . . uₙ^{λn+tn})^{γe-f}U^{γ}V.

The protocols are statistical honest verifier zero-knowledge if the commitment scheme mcom is unconditionally hiding. On the other hand, if the commitment scheme mcom is unconditionally binding then the protocols have unconditional soundness.

We next describe optimized MIX nets.

A traditional MIX net generally consists of a number of shuffle servers, each refreshing the randomness part of the encryption of encrypted votes, each permuting the votes and each producing a zero-knowledge proof that their output is a permutation and re-encryption of the input. In the final step the votes must be decrypted and zero-knowledge proofs must be included that the votes have been decrypted correctly. The correctness of the result of the election can be verified by an external audit facility, which verifies correctness of the counting by inspecting the input, output and zero-knowledge proofs of each server.

FIG. 1 shows a Mix net. The S servers re-encrypt (refreshes randomness) and permutes votes, whereas the S′ server decrypts votes. All provide zero-knowledge proofs that they have done their tasks correctly.

It is not desirable that the private key used for decryption is in the possession of only one entity. Therefore S′ should consist of several entities, which secret-share the private key of the election. However this solution is impractical.

As an example we take the [DGS] crypto system, that is ElGamal style. It is thus possible to share the secret key as explained above.

We will arrange embodiments of our voting system such that each shuffle partially decrypts the votes using its share of the secret key. The final server completes the decryption of the votes and produce zero-knowledge proofs of the correctness of the decryptions. In this way we will not need additional entities in order to perform the decryption securely. Two different types of embodiments using this type of encryption are possible.
Embodiments where the shuffles perform zero-knowledge proofs of the correctness of their actions and the cryptographic keys used for encrypting the input and the output are different.
Embodiments where the verification of correctness of votes and the computation of the result is done out of band (e.g. using different servers) using homomorphic encryption properties. This is done in such a way that the shuffle servers do not produce zero-knowledge proofs. Instead a zero-knowledge proof of correctness of the vote is produced when the vote is created. These zero-knowledge proofs are verified by “V”-servers and the votes are counted on encrypted form using the homomorphic property. Finally the results of the election in individual districts but not the individual votes are decrypted using a secret sharing mechanism. We will provide an example embodiment of our invention of this type. (In this case the maximal security is obtained with 3 shuffle servers and a server for decrypting the result. Three servers need to cooperate to break the secrecy in this case. We do not consider this to be a large problem since three shuffle servers is the natural choice).

A naïve MIX net implementation is not very fast. However, doing zero-knowledge proofs out of band of the shuffles and using other, generic, optimisations, it is possible to increase the throughput dramatically. We list a number of optimisations:
Partially decrypting in each shuffle and not providing zero-knowledge proofs gives a factor of about 3.
Partial decryption and re-randomization of votes can be parallelized arbitrarily. This gives an improvement of performance by a factor of 5-10.
The order in which the servers process each vote need not be the same for all votes. For example if there are three servers performing re-encryption, the votes can be distributed in three pools depending on their election district (since the result will normally be specified out for election districts, permutations between election districts are not relevant) and the pools are rotated between the re-encrypting servers until each vote has been once at each server. This gives a factor of about 3 compared to naively letting the first server finish its work before the next server starts.
If g is chosen in a subgroup of small order with elements that are indistinguishable from elements of the whole of Zₙ_{²}*, randomness and keys may be chosen shorter. Such optimisations are known for ElGamal over a prime and are also possible with ElGamal over a RSA modulus. It may give a factor 2-4 depending on the size of the RSA modulus of the crypto system. We thus describe a method of committing to an electronic data value, the method comprising selecting a substantially random number and a sub group of the multiplication group Z*ₙ of integers computed modulo n where n is a product of two primes for the electronic data value and/or said substantially random number and determining a commitment value from said electronic data value and said substantially random number using said subgroup

All in all this means that detachment of identities from votes can be performed about 45-90 times faster than for a naive MIX net implementation. The final decryption of votes can also be parallelized arbitrarily.

We next describe attacks against the scheme.

In order for a MIX net to have optimal security properties it is necessary that each shuffle server verify the zero-knowledge proofs of the predecessors before it performs its own MIX. As we have discussed this is not optimal with respect to performance, so it is fair to provide an account of the attacks made possible by not letting this verification take place.

If we count the votes by an out of band method, we can be sure that it will be discovered if the result of the election is altered. In one embodiment, we will provide, such a count is done securely using a homomorphic count. Thus we will have full security when it comes to making sure that the result of the election is correct.

However, some attacks against the secrecy of the election are possible. Since the crypto-system is homomorphic, the first S server can add numbers to votes and it can multiply the votes by a constant factor. This can normally be done in a way such that the vote as well as the number added can be separated from each other when the vote is decrypted. We will say that the encrypted votes are marked. Depending on which servers the first S server cooperates with different properties of the attack are possible.
If the first S server acts alone, the decrypting server will discover the fraud but also be presented for the association between identities of voters and votes cast.

If the decrypting server is honest, not compromised and checks whether votes are correctly formatted before they are published, the anonymity of the election will not be broken. Further, the fraud will be detected and a delayed count can take place with the first S server replaced.
If the first S server and the decrypting server work together, they will together be able to break the secrecy of the election completely. Because of the zero-knowledge proofs of correct decryption of votes, the fraud will be detected.
If the first S server and the decrypting server work together with all external audit facilities used, the abovementioned fraud need not be detected. (The decrypting server can in this case clean the votes before it publishes them and provide wrong zero-knowledge proofs that the audit facilities will let through undetected.)
If the first S server and the decrypting server work together with the last S server, they will be able to break the secrecy together without being detected. (The decrypting server decrypts votes, sends them back to the last S server, which cleans its encrypted output for the marks and submits a new, correct output.)

The basic properties are that two servers need to cooperate in order to break the secrecy, while accepting that their fraud will be detected. Three entities need to work together in order to break the secrecy without being detected. This can be improved on slightly by letting either the first or the last S server carry out a shuffle proof.

In the case, where we have two S servers and one decrypting server we see that there is no real loss of security. The two S servers could anyway break the secrecy by interchanging permutations. The first attack also has the equivalent that one of the S servers submits its permutation in clear text to the other S server. The other S server will of course detect and will (unwillingly) be able to break the secrecy.

We next describe write-in candidates.

In the US and some other countries it is common to use write-in candidates. That means that it is possible to vote for a candidate not on the list. This cannot be ignored for embodiments of systems to be applied in practice.

MIX nets can handle write-in candidates without problems, whereas homomorphic encryption can't deal with write-in candidates. Below we describe how homomorphic ‘encryption’ can however be used to prove that a list of write-in candidates is correct. First we give some background on commitment systems:

A verification system is a computationally hiding commitment system that is further supplied with a private key that breaks the computationally hiding property without breaking the commitment system properties. That means that a person in possession of a secret key X for the verification system will be able to verify a claim that a given commitment contains a given message without being provided with an opening of the commitment. However, knowledge of X will not provide any knowledge at all about the cipher-text space of the commitment system. In particular, the cipher-text space observed by a person with knowledge of X may appear to be an infinitely large space like Z just as if the person had not been in possession of X.

A homomorphic verification system is a verification system for which the underlying commitment system is homomorphic.

Example: Consider Zₙ, where n is an RSA modulus with unknown fractionation. Pick generators f and h of Zₙ* and set g=f^{X} for a randomly chosen X. We define the ElGamal style homomorphic system
V(m;r)=(f^{r},h^{m}g^{r})

Then V is a homomorphic commitment system and X is the secret key that breaks the computationally hiding property.

Please notice that V is not a crypto system. The discrete logarithm in Zₙ cannot be computed efficiently, so decryption is impossible if n is a large RSA modulus. In fact, if decryption were possible in general, the real message space would be known, which would imply breaking the RSA modulus, which is clearly not possible from the information given. Also in this way we see that the message space is Z, so the basic properties of the commitment systems are preserved. However notice that the commitment system is only computationally hiding rather than statistically hiding because it is possible to compute X for a computer with unlimited computing power.

In short we observe that this system has the property that the message space is all of Z, that the system is computationally hiding for an adversary without knowledge of the secret key, but entities with knowledge of the secret key are able to verify a claim efficiently that a commitment is a commitment to a particular value. Further, the private key can be secret shared like for other ElGamal style systems.

We remark that cryptographic primitives with the same properties as verification systems but without the homomorphic property are easy to construct from standard cryptographic primitives. For example one can take a hash function H with 16 byte output, consider the hash value H(m) as an AES key, use this key to encrypt a fixed value and finally encrypting the result using a public RSA key. This primitive allows persons in possession of the corresponding private RSA key to verify whether it was computed on a fixed value whereas it is computationally hiding for persons not in possession of the private key. Such a primitive could for example be used for time-stamping systems that allow only particular entities to verify time-stamps.

One novel aspect of embodiments of our invention of homomorphic verification systems is therefore the ability to verify several claims in one combined operation while keeping some properties of the individual claims secret. In the novel applications for voting systems we shall see, it will be the origin of the individual messages.

In an aspect of the invention use of homomorphic verification systems for verifying that messages m₁, . . . ,mₖ are authentic without revealing their origin in the following way: The entities {Eⱼ} producing the messages each choose large random numbers eⱼ, rⱼ and ρⱼ. They submit mⱼ, V(eⱼ, rⱼ) anonymously to one entity (entity A) and V(mⱼ eⱼ, ρⱼ) to another entity (entity B) in such a way that it is properly authenticated. The authenticity of the {mⱼ} is verified by having entity B submitting Π V(eⱼ, rⱼ)^{mj} to entity A, which computes C=Π V(mⱼ eⱼ, ρⱼ)⁻¹V(eⱼ, rⱼ)ₘⱼ. Finally a trusted entity, which knows X, verifies that C is a commitment to zero.

Let E denote a homomorphic crypto system. The implementation in the context of a voting system can be done as follows (for simplicity we use V as commitment system also, in practice some commitments would be done in a simpler system, which is preferably statistically hiding):
Let v be the vote, v=Σδj M^{j}. Some indices j represent write-in votes, whereas others represent candidate or list votes. M=p², where p is a prime. M is strictly larger than the number of votes any candidate can get. In particular, for elections where each voter has a single vote, M is strictly larger than the number of voters. (See [DGS], [DJ01]).
Submit E(v), V(Σδj p^{j}) together with a non-interactive zero-knowledge proof of equivalence between the two and a non-interactive zero-knowledge proof that the vote conforms with the rules of the election (see [DGS], [DJ01]).
Let m be a write-in vote corresponding to index k. (For example m=“Tom Jones” if the voter wants to vote for a person called Tom Jones that is not on the list. If a list candidate is selected instead, m should instead be a numeric zero, or another fixed value). Submit E(m), V(m) together with a non-interactive zero-knowledge proof of equivalence of E(m) and V(m) and a non-interactive zero-knowledge proof that either m=0 or δₖ=1. (This can be done by decomposing V(Σδj p^{j}) into two commitments v₁=V(δₖ p^{k}) and v₂=V(Σj≠k δj p^{j}), proving that either v₁ or V(−p^{k}) v₁ is a commitment to zero and proving that the content of either V(m) or V(−p^{k}) v₁ is a commitment to zero. Such proofs are standard.)
Pick a random number eₘ and submit V(eₘ) and V(meₘ) together with a multiplication proof that the content of V(meₘ) is the product of the content of V(eₘ) and V(m).
Sign the entire vote including all proofs.

Notice that the number eₘ will never become known to anybody since no encryption of it is submitted.

Now say that we count the votes by using the homomorphic property and decrypt the result. By using the homomorphic property we get the encryption:
V₁=V(Σ meₘ)=Π V(meₘ).

If we also use a ‘MIX net’, we get the individual numbers m and V(eₘ) coupled in pairs but detached from the identities of the voters. Thus we may compute
V₂=V(Σ meₘ)=Π V(eₘ)^{m}.

Using the secret key X, secret shared between the same persons that share the private key for the crypto system (homomorphic sharing, not the sharing between ‘MIX’ net servers), we can check that V₁ and V₂ have the same content. If the em were chosen large and random, there is in practice no way to fake this.

In an aspect of the invention we use the above mechanism to check the write-in votes coming out from a MIX net.

In an aspect of the invention we also use the above mechanism in the way that all votes are treated as written-in votes. i.e. instead of zero-knowledge proofs of correctness of normal votes one uses this mechanism.

In an aspect of the invention we also use the above mechanism for verifying correctness of encrypted information linking electronic ballots to paper ballots. (The information linking electronic votes to paper voters takes the role of m. This is similar to above except that in this case there need be no proof linking m to an ordinary vote.)

We next outline attacks against the scheme.

If the machines from where voters vote leak the eᵢ it may be possible for the last shuffle server and the decrypting server together to produce different m's. Notice however that this requires three cooperating entities and will with a high probability be detected by the tests against paper ballots in our invention.

Also some attacks against the secrecy of the election are possible. The first S server can replace E(mᵢ) and V(eᵢ) in some ways:
Replaced by E(mᵢ)^{1/2 mod n} and V(eᵢ)² or by higher powers of ½ and 2. If write-in votes are published no matter whether they make sense or not, or if the first S server works together with the decryption server, this can be used to check what individual voters voted. This will be detected unless further the last S server is also involved in the fraud.
Replaced by E(mᵢ)²E(−m₀) and V(eⱼ). This can be done and will pass all tests provided that the first S server correctly guesses the content of each vote it tampers with.

The last attack is potentially rather serious because the first S server can be buying votes and use it for verifying that the vote-sellers deliver. Consequently, as long as vote-sellers are honest this vote buying will not be detected. However, if a vote-seller does not deliver, the fraud will be detected. This attack (and similar ones with different powers than 2) can be made infeasible by including a few random bits in each vote at a specific location.

Again we conclude that whereas this is not quite as secure as a MIX net where all shuffle-proofs of predecessors are verified before the next shuffle server starts, attacks against the integrity of the election require three cooperating entities and will be detected with a high probability whereas attacks against the secrecy of the election with potential for not being discovered require at least two cooperating entities if the votes are enhanced with a few random bits.

We now describe signing votes.

We first remark that embodiments of the inventions claimed are possible without using digital signatures. Nevertheless it is preferable that encrypted votes are digitally signed such that there is 100% accountability about exactly where each electronic vote came from. Some pilot systems have attempted to use chip cards for that purpose, but face the difficulty that chip cards are expensive and that chip cards with signing keys are not widespread. The Cybervote project is an example. DRE systems also use chip cards, but in a different way that is not related to digital signatures and does not provide the accountability we are discussing.

Alternatives to using a portable device like a chip card to store the private keys of the voter on are not store the private key; or store the private key in a non-portable device.

The first option is taken in the e-Vote project, where the Internet-voting pilot system works in the way that a public/private key pair is generated in an applet running on the computer of the voter. A certificate on the public key is then issued on the fly based on credentials that the voter receives by mail such that the vote can be properly signed. Depending on the procedures applied for distributing the credentials and the properties, configuration and operation of the on-line CA, this may be a legally binding signature. By using this mechanism the e-Vote system is optimal in the sense that it uses the simplest and cheapest possible mechanism for creating legally binding signatures on encrypted electronic votes.

For an e-voting system that takes place at election sites it is however unacceptable that the devices used for casting votes store the private key of the voter (when also, supposedly, only for a short time). The remaining option is thus to store the private key in another, non-portable device. Such a device—which we call the Signer—is described in our patent application PCT/GB02/03707, WO03/015370, hereby incorporated in its entirety by reference. The Signer can then be operated at central locations different from election sites. Digital signatures are produced by the Signer on the basis of credentials provided by the voters, and each digital signature is logged by the Signer.

It is strongly preferable that two-factor authentication is used for voting. We preserve the option that the voter receives both factors in one letter. This is not really a problem since the identity of the voter can be checked when giving off the first factor (with the same level of scrutiny that is used for manual elections, that differs a lot from country to country). The central point is that vote buying must be prevented by having a public and a private authentication factor. One factor is preferably used in the public sphere, such that vote buying by buying credentials can be prevented. The other factor is used in privacy when the vote is cast, such that accountability is assured. The Signer is designed to deal with two-factor authentication in a highly secure and tamper resistant way since it is distributed in two servers that each know of one factor of the authentication.

We conclude that circumstance dictate the Signer approach to be the preferred solution, both cost-efficient and secure to use. However, if the Signer is used it is sufficient that each voter receives a voter card by mail as usual with two authentication factors printed on it in order to produce digital signatures.

Use of the Signer preferably requires the e-Voting system to be on-line. However the security (at least security against undesired influence on the outcome of elections) does not rely on confidence in the device used for casting votes and printed ballots may serve as backup in case of lacking on-line availability (i.e. a manual count).

We next describe some example embodiments.

First we give two examples of how to encrypt information linking electronic and paper ballots
1) Enlarge homomorphically encrypted votes (like the cryptosystems in [DJ] or [DGS]) such that the plain-text space is Zₙs+1 instead of Zₙs and the cipher space is correspondingly Zₙs+2 instead of Zₙs+1. Represent (vote, manual ballot) as vote +n^{s} (manual ballot). Project the encrypted vote on Zₙs+1 before doing the zero-knowledge proof of correctness of the vote (this corresponds to removing the term n^{s} (manual ballot) in the plain text space). See [DJ01], hereby incorporated by reference, for further details about how this machinery works.
2) Combine two homomorphic encryption keys to produce a key with the product cipher space and cleartext space. We let the orders of clear-text spaces and ciphertext spaces be mutually prime for letting the product space have similar properties to the component spaces. Do homomorphic encryption proofs in the vote space only, but do the MIX net proof in the product space (if a MIX net proof is done).

We describe a realization below that is as simple as possible. This system is an example of a traditional MIX net system enhanced with additional information linking electronic ballots and paper ballots:

Referring to FIG. 2 we describe the individual components:
The “Registration Facility” is a public sector system for keeping track on the eligible voters. The registration facility interfaces with the Signer for registering voters for the system.
The Signer is the signature server referred to above, which is used for keeping track on voter credentials and voter identities in the voting system and for signing electronic votes. When voters are registered on the Signer, the Signer registers them at a CA for certification. The Signer further sends credentials to the voters and makes available functions for disabling voters who cease to be eligible or loose their credentials.
The CA issues certificates on voters.
The “Enter Voting Site Application” accepts one credential from the voter, which is provided in public. In this way it is prevented that voters can buy credentials and bring more credentials with them into the place where votes are cast. A manual check of the voter identity is carried out when the “Enter Voting Site Application” is used. The “Enter Voting Site Application” is also responsible for handling and logging most exceptions to the normal flow of events (examples: A voter identifies himself but has lost his credentials. A voter loses his second piece of authentication inside the voting site. A voter changes his mind before submitting the paper ballot but after having submitted the electronic ballot). There are many routine ways of handling such exceptions.
The “Voting Application” is the application/machine used for casting votes. This can for example be a touch screen machine. If write-in votes are possible, an equivalent of a keyboard should be available for entering the name and possible more information on the write-in candidate. The voter selects his choices and gives off his second credential that is used for having the Signer signing the vote. As a result an electronic ballot and a paper ballot are created. The liking information can, for example, be created by the Voting Application as an identifier of the election district followed by random numbers generated at the time of voting. It can, for example, be included in the electronic vote in the way described above and it can for example be represented in bar code on the backside of the printed ballot. The electronic vote is sent on-line to a collection point, whereas the voter carries the manual vote out in the public sphere, where he enters it into a traditional ballot box.
The “Local Check Program” is a program used for checking the votes after the election is finished. (Scanning of information linking paper ballots to electronic ballots, checking correspondence by carrying out an interactive protocol with the on-line election result entity with information on electronic ballots, checking that the number of paper ballots equals the number of electronic ballots and checking a selected number of ballots, in embodiments less than 200, with the corresponding electronic ballot, again by carrying out an interactive protocol with the “On-line Election Result” entity.)
The “Collection Point” is a server, which collects votes from at least one district and checks syntax and digital signatures on the votes.
The S servers are servers holding a share of the private keys of the election. They partially decrypt and permute votes and generate a non-interactive zero-knowledge proof that they have done the job correctly.
The S′ server performs the last part of the decryption and provides a non-interactive zero-knowledge proof of correctness of the decryption of each individual vote.
The “Key Generation Application” is an off-line application operated under particularly stringent security measures used prior to the election for generating key pairs of the election (crypto system, commitment system). The public keys and private key parts are distributed to the relevant entities. Notice that the S servers should be operated by different organizations/persons in order to ensure secrecy of votes.

Referring to FIG. 3 we describe a realization below that is optimized for performance and security in the sense that performance-demanding generation of zero-knowledge proofs is done at the election sites and verification is scalable, such that all zero-knowledge proofs can be verified before the result is published.

We briefly describe the individual components:
The registration facility is a public sector system for keeping track on the eligible voters. The registration facility interfaces with the Signer for registering voters for the system.
The Signer is the signature server referred to above, which is used for keeping track on voter credentials and voter identities in the voting system and for signing electronic votes. When voters are registered on the Signer, the Signer registers them at a CA for certification. The Signer further sends credentials to the voters and makes available functions for disabling voters who cease to be eligible or loose their credentials.
The CA issues certificates on voters.
The “Enter Voting Site Application” accepts one credential from the voter, which is provided in public. In this way it is prevented that voters can buy credentials and bring more credentials with them into the place where votes are cast. A manual check of the voter identity is carried out when the “Enter Voting Site Application” is used. The “Enter Voting Site Application” is also responsible for handling and logging most exceptions to the normal flow of events (examples: A voter identifies himself but has lost his credentials. A voter looses his second piece of authentication inside the voting site. A voter changes his mind before submitting the paper ballot but after having submitted the electronic ballot).
The “Voting Application” is the application/machine used for casting votes. This can for example be a touch screen machine. The voter selects his choices and gives off his second credential. If write-in votes are possible, an equivalent of a keyboard should be available for entering the name and possible more information on the write-in candidate. As a result an electronic and a paper ballot are created. The linking information can for example be created by the Voting Application as an identifier of the election district followed by random numbers generated at the time of voting. It can for example be included in the electronic vote in the way described above and it can for example be represented in bar code on the backside of the printed ballot. A non-interactive zero-knowledge proof of correctness of the electronic vote is attached to the electronic vote. The electronic vote is signed by the Signer using the second credential of the voter. The electronic vote is sent on-line to a collection point, whereas the voter carries the manual vote out in the public sphere, where he enters it into a traditional ballot box.
The “Local Check Program” is a program used for checking the votes after the election is finished. (Scanning of information linking paper ballots to electronic ballots, checking correspondence by carrying out an interactive protocol with the on-line election result entity with information on electronic ballots, checking that the number of paper ballots equals the number of electronic ballots and checking a selected number of ballots, presumably less than 200, with the corresponding electronic ballot, again by carrying out an interactive protocol with the “On-line Election Result” entity.)
The “Collection Point” is a server, which collects votes from at least one district and checks syntax and digital signatures on the votes.
The S servers are servers holding a share of the private keys of the election. They re-encrypt and permute votes (zero-knowledge proofs and the signature are removed).
The S′ server performs the last part of the decryption and provides a proof of correctness of the decryption of each individual vote.
The “Key Generation Application” is an off-line application operated under particularly stringent security measures used prior to the election for generating key pairs of the election (homomorphic crypto system, homomorphic commitment system and homomorphic verification system). The public keys and private key parts (secret shared in two different ways) are distributed to the relevant entities. Notice that the S servers should be operated by different organizations/persons in order to ensure secrecy of votes.
The V servers are used for verifying zero-knowledge proofs on the individual votes. Notice that the scheme for write-in candidates, where also list votes are checked using a verification system, allows for no V servers. This however has the disadvantage (as in all schemes involving depersonalization of votes only) that votes filled in ways that should not be allowed by the software of the Voting Application cannot be traced back to their origin. With V servers in place votes with invalid zero-knowledge proofs can be linked to the identity of the voter. Therefore there is a significant role to play for V-servers.
The “Homomorphic Count” is a server where votes with valid zero-knowledge proofs are counted on encrypted form using the homomorphic property without decrypting individual votes. Further, write-in votes and the electronic version of the information linking electronic and paper ballots can be taken in to do a full verification. In an interaction with a trusted group of people each holding a secret share of the private keys of the election, the result of the election is decrypted. A complete audit trail with zero-knowledge proofs that everything has been done correctly is produced and stored/exported for external audit.
The TS servers are threshold servers, applications that allow the key share holders to use their key shares for decrypting the result of the election.
The “External Audit Facility” is a facility that checks that the steps carried out by the V servers and the homomorphic count were performed correctly.

Please notice that not all relevant arrows are included in the drawing. For example arrows with origin at the key generation server have been left out for simplicity. Further, feed-back is helpful in a number of situations in order to deal with error and fraud situations. For example feed-back from the V-servers to the collection point is preferable in the case, where there are votes with valid content but invalid zero-knowledge proofs.

The invention also provides, in a further aspect of a special variant of a user interface to the local check program. An embodiment of this is described below:
The container for collecting ballots is separated into two or more physical containers.
When the voter wants to submit his vote he physically interacts with the device resulting in the device bringing itself in a mode, where it is possible for the voter to enter his ballot in at least one of the containers but not both/all.
The ballots entered into one/some of the containers will be subjected to checks against the electronic ballots, possibly different types of checks depending on the container, whereas the ballots entered into (the) other container(s) will not be checked against electronic ballots.

FIG. 4 shows a device for selecting ballots to be checked. A more sophisticated version of such a device is also possible. In addition to a button to press for entering a ballot a scanner is available. The procedure is as follows:
The voter presses the button (or in another way makes aware that the device must make its choice).
The device indicates which slot will be opened, for example by lighting up the slot to be opened.
The voter uses a scanning device to scan the information on his ballot linking it to an electronic ballot.
The device opens the slot indicated.
The voter enters his vote.

In this way the manual ballots will all be processed during the election with exception of the reading of the content of ballots to be checked. This simplifies the step after the election is over to actually enter the content of the ballots to be checked.

The two steps, first pressing the button, only then scanning the ballot, are there to ensure that it will be substantially impossible for the electronic voting system to signal to the device in a reliable way, which ballots shall not be checked.

FIG. 5 shows a device for selecting ballots to be checked with scanner. In order to apply this scheme it is preferable to form the ballots in a way such that the information linking them to electronic ballots can be scanned without revealing the content of the ballot. This can be done by having the information linking the physical and electronic ballots written on the backside of the physical ballots near the top or the bottom of the ballot.

FIG. 6 shows a ballot with scannable text field.

FIG. 7 illustrates the information that can be contained in a paper ballot and in the corresponding electronic vote. The shaded area is the part of the electronic vote that is encrypted.

FIG. 8 illustrates how the encrypted content, but not the digital signatures and zero-knowledge proofs may be homomorphically counted on encrypted form to deliver an encrypted result in a homomorphic count.

FIG. 9 illustrates how a shuffle changes the encryption and the ordering of electronic votes and produces a zero-knowledge proof of the correctness of its actions.

In embodiments where electronic votes rather than printed ballots are sampled, we propose that the “On-line Election Result” component or a component with access to the information provided by the “On-line Election Result” component selects the sample. The election districts with samples to check are then informed and must now count their printed ballots, find the printed ballots corresponding to electronic ballots and verify that the selection of candidates on the manual ballots is the same as in the electronic ones. Comprehensive procedures and protocols that can be a combination of manual steps and cryptographic protection in the communication between the election district and the entity selecting the samples are preferably employed in order to make sure that the information communicated correctly reflects the information contained in electronic and printed ballots. It is also possible that a person from the organization selecting the samples will be personally present in the individual election districts to inspect printed ballots directly or that printed ballots corresponding to electronic votes sampled or all printed ballots in the district are submitted for independent audit.

When the election is over many options are available for verification and fine counting, providing full accountability of the system:
1) Verifying correctness of the verification and counting by an independent organization using independent software. This is standard universal verifiability carried out at the “External Audit Facility”.
2) Verifying the Signer log against the votes. In particular verifying that there is no systematic double signing. Voters who have signed more than once can be double-checked for, whether they got the permission (log from “Entry Election Application”).
3) Selecting an adequate number of randomly chosen depersonalized votes for the whole country (a predetermined number, for example about 459 (or more) in our proposed solution). Do a test that each of those votes corresponds to a manual vote by a manual procedure in election districts.
4) For each district, selecting an adequate number of randomly chosen votes (a predetermined number, for example about 194 in our proposed solution). Do a test that each of those votes corresponds to a manual vote by a manual procedure in election districts. In contrary to 3), this work can be distributed over months (however, in the example embodiments given, it is done just after the election or even in parts during the election).

If 1)-4) are all successful and no other factors indicate that there is increased risk that this election has been tampered with, it will be natural to stop here. If however, one of the tests is not successful, a number of steps can be taken.
5) Electronic logs from voting sites can be compared to central logs from the Signer and the counting facilities. The result of this comparison may give an indication about, in which parts of the country a closer investigation shall take place.
6) Selected or all districts can perform a manual recount.
7) Selected or all districts can perform an extended manual recount involving the following: All electronic votes cast in the district are depersonalized in a MIX net. Each electronic vote is matched with a printed ballot.
8) In districts where the abovementioned pairing of electronic and manual votes cannot be performed with sufficient success, a new election may be called for.
9) It is also possible with the help of highly trusted persons holding shares of the key used for decrypting the result of the election, to call in voters and have their votes decrypted such that they can judge about, whether fraud has taken place in the manual or the electronic system.

We observe that with the embodiments of the system proposed, benefits of several kinds can be achieved:
Cost savings: For elections carried out in an orderly fashion, costs for counting can be limited significantly by having few locations, where counting takes place and counting votes almost 100% electronically.
Increased services to voters: If the system is designed to do so, voting from arbitrary voting sites for each voter is possible because everything is electronic.
Security: If the result of an election is disputed, there is much better accounting that in a manual election because the printed ballots can be compared to the electronic ones to establish which ballots have been tampered with.

Not all embodiments are optimal on each individual category, for example Internet-voting systems without security features build in optimize the first two while completely sacrificing the third. However, we describe a good compromise and leave a lot of room for election organizers to select just the solution that meets their requirements optimally. For example the scheme described is compatible with having Internet-voting also for selected categories of voters, like voters living abroad.

No doubt many effective alternatives will occur to the skilled person. It will be understood that the invention is not limited to the described embodiments and encompasses modifications apparent to those skilled in the art lying within the spirit and scope of the claims appended hereto.

1.-43. (canceled)

44. An electronic voting system, the system comprising:
a voting device configured to generate, in response to a voter selection for each of a plurality of voters an encrypted electronic ballot and a printed ballot, both having voter selection data indicating a said voter's choice, said electronic ballot including information to link it to said printed ballot and said printed ballot including information to link it to said electronic ballot;
an electronic vote decryption system configured to receive electronic ballots from said voting device and to decrypt said encrypted electronic ballots including said linking information; and
a voting verification system configured to receive decrypted voter selection data and linking information from said vote decryption system, to receive voter selection data and linking information from said printed ballots and to compare voters choices for a sample of said printed and electronic ballots linked by said linking information, to verify the voting.

45. An electronic voting system as claimed in claim 44 further comprising a ballot box to receive said printed ballots, and a printer coupled to said voting device to print a said printed ballot for verification by a voter prior to reception of said printed ballot by said ballot box.

46. An electronic voting system as claimed in claim 45 wherein said ballot box includes means to select a sample of said printed ballots for said voting verification system.

47. An electronic voting system as claimed in claim 44 wherein said linking information included with said printed ballot is printed onto said ballot such that it is not directly readable by a human.

48. An electronic voting system as claimed in claim 44 wherein said sample comprises a predetermined number of ballots of at least 190, or at least 450.

49. An electronic voting system as claimed in claim 44 wherein said voter verification system is further configured to determine that all said printed ballots carry different linking information, that each said printed ballot links to an electronic ballot, and that the number of printed ballots is the same as the number of electronic ballots.

50. An electronic voting system as claimed in claim 44 wherein said encrypted electronic ballot includes voting district identification information, and wherein said comparing of printed and electronic ballots is performed for a selected said district.

51. An electronic voting system as claimed in claim 44 wherein a said electronic ballot includes voter identification information, and wherein said vote decryption is further configured to separate said voter selection data from said voter identification information prior to providing said voter selection data to said voting verification system.

52. An electronic voting system as claimed in claim 51 wherein said separating comprises a mix-net shuffle operation to provide at least one shuffle of said voter selection data.

53. An electronic voting system as claimed in claim 52 wherein said shuffle operation provides a plurality of shuffles in which each shuffle has a share of a secret key, and in which each shuffle partially decrypts said encrypted electronic ballots using said secret key share.

54. An electronic voting system as claimed in claim 52 wherein said decryption system includes at least one first server to implement said mix-net, and at least one second server to provide verification data to demonstrate that a said shuffle does not modify a said voter's choice.

55. An electronic voting system as claimed in claim 54 wherein said verification data comprises a zero-knowledge proof, and further comprising an audit system to output audit data, said audit system including a homomorphic verification system to operate on said verification data from said plurality of shuffles to count votes with verified zero-knowledge proofs without decrypting a said encrypted electronic ballot.

56. An electronic voting system as claimed in claim 44 further comprising means to process write-in-votes.

57. An electronic voting system as claimed in claim 44 further comprising a signer to sign a said electronic ballot, said signer being coupled to said voting device and configured only to produce a digital signature for a said electronic ballot in response to input of at least two items of voter authentication.

58. A computer system for verifying an electronic voting system as claimed in claim 44, the computer system comprising:
data memory operable to store data to be processed;
program memory storing processor implementable instructions; and
a processor coupled to said data memory and to said program memory to load and implement said instructions, the instructions comprising instructions for controlling the processor to:
receive decrypted voter selection data and linking information from said vote decryption system;
receive voter selection data and linking information from said printed ballots; and
compare voters' choices for a sample of said printed and electronic ballots linked by said linking information to verify the voting.

59. A computer system as claimed in claim 58 wherein said instructions further comprise instructions for controlling the processor to:
determine that all said printed ballots carry different linking information;
determine that each said printed ballot links to an electronic ballot; and
determine that the number of printed ballots is the same as the number of electronic ballots;
to thereby verify said voting.

60. A carrier carrying the processor implementable instructions of claim 58.

61. A device for collecting ballots for the electronic voting system of claim 44, the device comprising:
a ballot input to accept a ballot submitted by a user;
a first ballot holder for holding ballots for checking;
a second ballot holder; and
a user interface to allow said user to signal to the device an intention to submit said ballot; and
a selector responsive to said signal to select substantially at random one of said first and second ballot holders to receive said submitted ballot.

62. A claim as claimed in claim 61 further comprising a ballot reader to read information on a said ballot linking the ballot to an electronic ballot; and wherein in response to said signal the device is configured to select a said ballot holder, to indicate said selection to said user, and then to read said linking information on ballot.

63. A printed ballot for an electronic voting system configured to count electronic ballots corresponding to printed ballots, said printed ballot bearing information linking the ballot to a said electronic ballot and information to allow a voter to identify one or more choices, the printed ballot being configured or configurable such that said linking information and said choice identification information are both visible, but not simultaneously.

64. A printed ballot as claimed in claim 63 wherein said linking information and said choice identification information are on opposite sides of said ballot.

65. A method of operating an electronic voting system, the method comprising:
collecting a vote from a voter;
outputting vote as both an encrypted electronic ballot and a printed ballot, each of said printed and encrypted electronic ballots bearing information linking it to the other;
displaying the printed ballot to the voter;
collecting the printed ballot;
repeating said collecting, outputting, displaying and collecting for a plurality of other voters;
decrypting and counting said electronic ballots;
selecting a sample of said printed or electronic ballots and reading voter choices for said sample;
reading voter choices for electronic or printed ballots linked to said selected ballots by said linking information; and
comparing said voter choices read from said sample and said linked ballots to verify a result of said voting.

66. A method as claimed in claim 65 wherein said encrypted distance ballots are homomorphically encrypted, the method further comprising repeatedly permuting and re-encrypting said electronic ballots prior to said decrypting; and verifying said result using a homomorphic verification system.

67. A method as claimed in claim 66 wherein said verifying comprises verifying the correctness of said linking information.

68. A method as claimed in claim 66 wherein said repeated permuting and re-encrypting further comprises partial decryption of a said electronic ballot.

69. A method as claimed in claim 66 further comprising producing and verifying a zero-knowledge proof of said repeated permuting and re-encrypting.

70. Computer program code on a carrier to implement the method of claim 65.

71. A method of committing to an electronic data value, the method comprising selecting a substantially random number and a sub group of the multiplication group Z*ₙ of integers computed modulo n where n is a product of two primes for the electronic data value and/or said substantially random number and determining a commitment value from said electronic data value and said substantially random number using said subgroup.

72. A method of providing information for verifying correctness of a permutation of encrypted messages performed using one or more data processing entities, the method comprising:
sending a commitment (cₛ) to a first set of values (π) defining said permutation to a verifier;
receiving a second set of values (t) from said verifier;
permuting said second set of values with said permutation;
sending a commitment (cₜ) to said permuted second set of values to said verifier; and
sending additional information to said verifier for verifying correctness of said permutation, said additional information verifying that said second set of values was permuted with said permutation.

73. A method as claimed in claim 72 wherein said sending of additional information comprises:
receiving a pair of challenge values (λ, x) from said verifier;
determining a third set of values (a) from said permutation, said second set of values and said pair of challenge values and sending a commitment (cₐ) to said third set of values to said verifier;
determining and sending a commitment (c_{d}) to a fourth set of random values (d) to said verifier;
determining a fifth set of random values (Δ) and sending a commitment (c_{Δ}) to a combination of said fourth and fifth sets of values to said verifier;
sending a check value (E) derived from a further random value (R) to said verifier;
receiving a further challenge value (e) from said verifier; and
sending values (f, z, Z) determined from said further challenge value, said pair of challenge values, said further random value, and said permutation to said verifier;
whereby said verifier is able to verify said correctness using a zero-knowledge protocol.

74. A method of providing information for verifying correctness of a combined permutation and partial decryption of encrypted messages performed using one or more data processing entities, the method comprising:
sending information to said verifier for verifying correctness of said combined permutation and partial decryption, said information comprising information to enable said verifier to verify said performance using a zero-knowledge protocol.

75. A method as claimed in claim 74 wherein said information sending comprises:
sending a commitment (cₛ) to a first set of values (π) defining said permutation to a verifier;
receiving a second set of values (t) from said verifier;
permuting said second set of values with said permutation;
sending a commitment (cₜ) to said permuted second set of values to said verifier;
receiving a pair of challenge values (λ, x) from said verifier;
determining a third set of values (a) from said permutation, said second set of values and said pair of challenge values and sending a commitment (cₐ) to said third set of values to said verifier;
determining and sending a commitment (c_{d}) to a fourth set of random values (d) to said verifier;
sending a triplet of check values (D, U, V) derived from a pair of random values (d, R) to said verifier;
receiving a further challenge value (e) from said verifier; and
sending values (f, z, Z) determined from said further challenge value, said pair of challenge values, one of said pair of random values, and said permutation to said verifier.

76. A method of shuffling and decrypting encrypted electronic data using a plurality of data processing entities, each entity having a share of a secret key, the method comprising, at each of said entities, partially decrypting and re-randomizing said electronic data using said secret key share such that a final said data processing utility fully decrypts said data.

77. A method as claimed in claim 76 further comprising shuffling said electronic data and generating a shuffle proof for verifying said shuffling at each said data processing entity.

78. A method as claimed in claim 77 further comprising verifying each said shuffle with one or more data processing entities.

79. A method, in a computer system, of providing data for verifying that messages of a set of messages provided from a corresponding set of entities are authentic, the method comprising:
selecting, for each said entity, first second and third random numbers;
determining, for each said entity, first and second verification values from, respectively, said first and second random numbers and said entity's message, and said first and third random numbers; and
outputting, for each entity, said entity's message and said first and second verification values.

80. A method for providing data for verification systems for verifying that messages m₁, . . . ,mₖ are authentic using a homomorphic verification system without revealing their origin, the method comprising entities {Eⱼ} producing the messages each choosing random numbers eⱼ, rⱼ and ρⱼ and submitting mⱼ, V(eⱼ, rⱼ) anonymously to one entity (entity A) and V(mⱼ eⱼ, ρⱼ) to another entity (entity B) where V is a verification function, in particular a homomorphic function, in such a way that the messages are authenticated.

81. A method for verifying messages using data provided as claimed in claim 80 wherein the authenticity of {mⱼ} is verified by having entity B submitting Π V(eⱼ, rⱼ)^{mj} to entity A, which computes C=Π V(mⱼ eⱼ, ρⱼ)⁻¹V(eⱼ, rⱼ)^{mj}, then an entity which knows a secret key for V verifying that C is a commitment to zero.

82. Use of the method of claim 80 to check write-in votes outputted from a MIX net.

83. Use of the method of claim 80 for proving correctness of electronic votes in a voting system.

84. Use of the method of claim 80 for verifying correctness of encrypted information linking electronic ballots to paper ballots.

85. A carrier carrying computer program code to, when running, implement the method of claim 71.
